(19) United States
(12) Patent Application Publication
(10) Pub. No.: US 2026/0323640 A1
(43) Pub. Date: Oct. 15, 2026

(54) REPETITION FOR DOWNLINK COVERAGE ENHANCEMENT

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US)

(21) Appl. No.: 19/449,336

(22) Filed: Jan. 14, 2026

Related U.S. Application Data
(60) Provisional application No. 63/750,093, filed on Jan. 27, 2025.
(60) Provisional application No. 63/755,018, filed on Feb. 6, 2025.

(51) Int. Cl. H04W 72/1273; H04W 72/232

(52) U.S. Cl. CPC H04W 72/1273; H04W 72/232

(57) ABSTRACT

A method of operating a user equipment (UE) includes receiving, from a base station (BS), system information including configuration information associated with Message 4 (Msg4) physical downlink shared channel (PDSCH) repetition. The method also includes, during a four-step random access procedure, transmitting, to the BS, a Message 3 (Msg3) including an indication that the UE supports Msg4 PDSCH repetition, and in response to transmission of the Msg3, (i) receiving downlink control information (DCI) scheduling a Msg4 PDSCH repetition, and (ii) repeatedly receiving a Msg4 PDSCH scheduled by the DCI.

### CROSS-REFERENCE TO RELATED APPLICATION(S) AND CLAIM OF PRIORITY

This application claims priority under 35 U.S.C. § 119(e) to U.S. Provisional Patent Application No. 63/750,093 filed on Jan. 27, 2025, and U.S. Provisional Patent Application No. 63/755,018 filed on Feb. 6, 2025. The above-identified provisional patent applications are hereby incorporated by reference in their entirety.

### TECHNICAL FIELD

This disclosure relates generally to wireless networks. More specifically, this disclosure relates to repetition for downlink coverage enhancement.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for repetition for downlink coverage enhancement.

In one embodiment, a method of operating a user equipment (UE) is provided. The method includes receiving, from a base station (BS), system information including configuration information associated with Message 4 (Msg4) physical downlink shared channel (PDSCH) repetition. The method also includes, during a four-step random access procedure, transmitting, to the BS, a Message 3 (Msg3) including an indication that the UE supports Msg4 PDSCH repetition, and in response to transmission of the Msg3, (i) receiving downlink control information (DCI) scheduling a Msg4 PDSCH repetition, and (ii) repeatedly receiving a Msg4 PDSCH scheduled by the DCI.

In another embodiment, a method of operating a BS is provided. The method includes transmitting, to a UE, system information including configuration information associated with Msg4 PDSCH repetition. The method also includes, during a four-step random access procedure, receiving, from the UE, a Msg3 including an indication that the UE supports Msg4 PDSCH repetition, and in response to receiving the Msg3, (i) transmitting downlink control information (DCI) scheduling a Msg4 PDSCH repetition, and (ii) repeatedly transmitting a Msg4 PDSCH scheduled by the DCI.

In yet another embodiment, an electronic device is provided. The electronic device includes at least one processor including processing circuitry, and memory storing instructions. The instructions, when executed by the at least one processor individually or collectively, cause the electronic device to receive, from a BS, system information including configuration information associated with Msg4 PDSCH repetition. The instructions, when executed by the at least one processor individually or collectively, also cause the electronic device to, during a four-step random access procedure, transmit, to the BS, a Msg3 including an indication that the electronic device supports Msg4 PDSCH repetition, and in response to transmission of the Msg3, (i) receive DCI scheduling a Msg4 PDSCH repetition, and (ii) repeatedly receive a Msg4 PDSCH scheduled by the DCI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein: [1] 3GPP, TS 38.300 v18.4.0, 5G; NR; NR and NG-RAN Overall Description; Stage 2; [2] 3GPP, TS 38.331 v18.4.0, 5G; NR; Radio Resource Control (RRC); Protocol specification; [3] 3GPP, TS 38.321 v18.4.0, NR; Medium Access Control (MAC) protocol specification; [4] 3GPP, TS 38.304 v18.4.0, NR; User Equipment (UE) procedures in Idle mode and RRC Inactive state; and [5] 3GPP, TS 38.306 v18.4.0, NR; User Equipment (UE) radio access capabilities.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for 4-step CBRA with a Msg3 including a request/capability for Msg4 PDSCH repetition according to embodiments of the present disclosure;

FIGS. 5-7 illustrate example MAC subheaders according to embodiments of the present disclosure;

FIG. 8 illustrates an example procedure for 2-step CBRA with MsgB PDSCH repetition according to embodiments of the present disclosure;

FIG. 9 illustrates an example procedure for Fallback CBRA with Msg4 PDSCH repetition according to embodiments of the present disclosure;

FIG. 10 illustrates an example method for repetition for downlink coverage enhancement according to embodiments of the present disclosure; and

FIG. 11 illustrates another example method for repetition for downlink coverage enhancement according to embodiments of the present disclosure.

### DETAILED DESCRIPTION

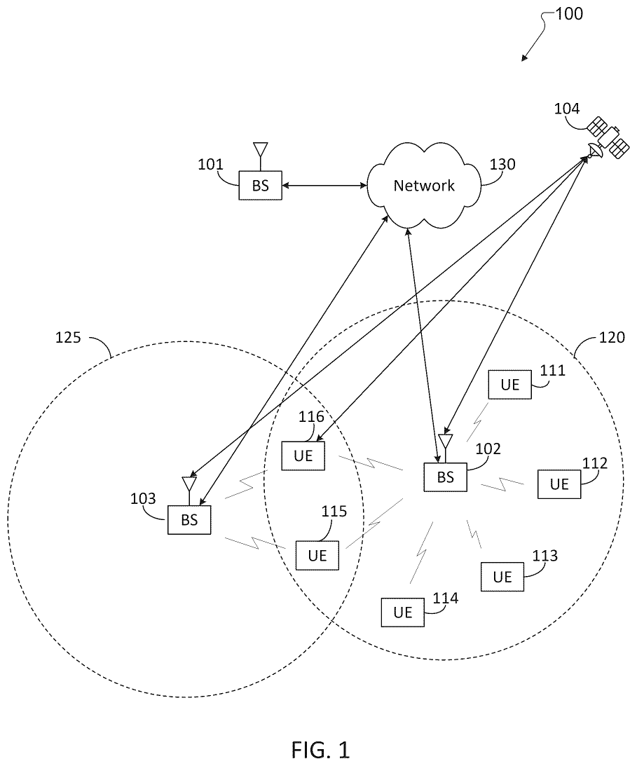

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to common fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Taking into account the capabilities of providing wide coverage and reliable service, an NTN is envisioned to ensure service availability and continuity ubiquitously. For instance, an NTN can support communication services in unserved areas that cannot be covered by other terrestrial networks (TNs), in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for repetition for downlink coverage enhancement. In certain embodiments, one or more of the gNBs 101-103 includes circuitry, programing, or a combination thereof, to support repetition for downlink coverage enhancement in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

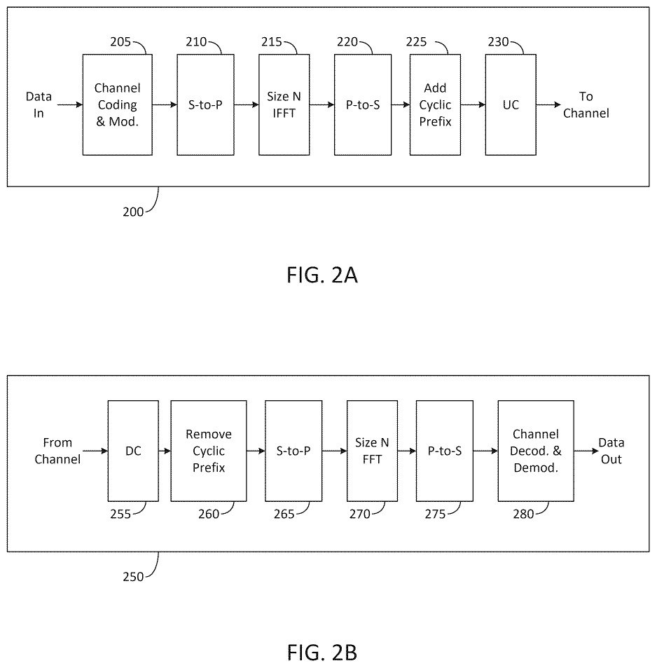

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support repetition for downlink coverage enhancement as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

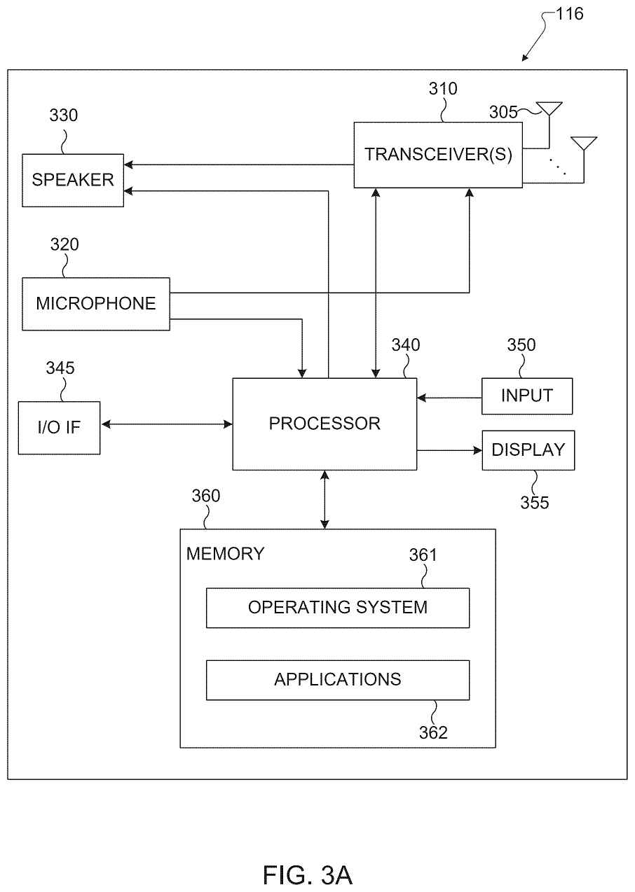

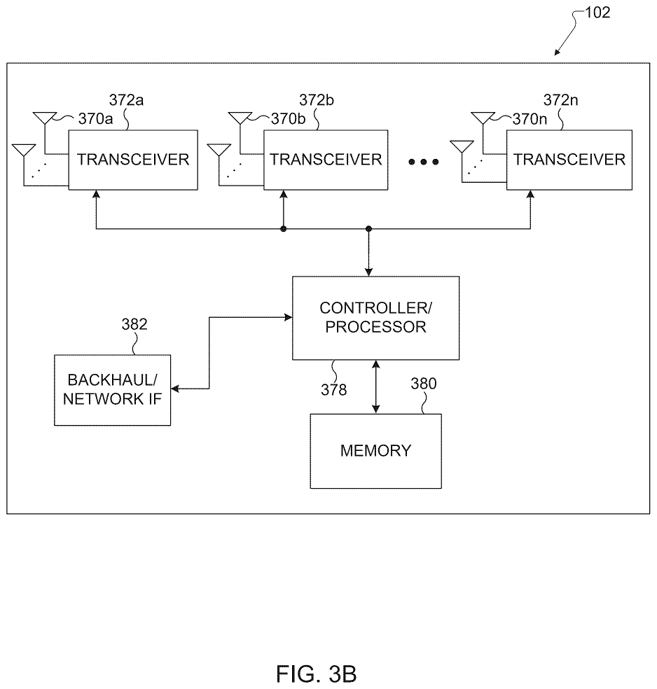

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for repetition for downlink coverage enhancement as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support repetition for downlink coverage enhancement as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The Third-Generation Partnership Project (3GPP) has developed technical specifications and standards to define a fifth generation (5G) radio-access technology, known as 5G New Radio (NR). To improve NR downlink coverage, repetition of the Physical Downlink Control Channel (PDCCH) and Physical Downlink Shared Channel (PDSCH) are supported. The PDCCH can be used to schedule DL transmissions on the PDSCH and UL transmissions on Physical Uplink Shared Channel (PUSCH), where the Downlink Control Information (DCI) on the PDCCH includes DL assignments containing at least modulation and coding format, resource allocation, and hybrid-ARQ information related to DL-SCH, UL scheduling grants containing at least modulation and coding format, resource allocation, and hybrid-ARQ information related to the Uplink Shared Channel (UL-SCH), and other control information.

A UE monitors a set of PDCCH candidates in the configured monitoring occasions in one or more configured COntrol REsource SETs (CORESETs) according to the corresponding search space configurations. A CORESET refers to a PDCCH decode region which includes a set of physical resources. Search Space is an area within a CORESET that the UE should monitor to detect a specific PDCCH/DCI. A CORESET may have multiple search spaces. The search space is where the UE attempts blind decoding. By definition, each search space is a set of control channel elements at a different aggregation level(s). In other words, a search space tells how many candidates are there to decode at different aggregation levels.

There are two types of search spaces called “UE-specific search space” (USS) and “Common Search Space” (CSS). A USS is dedicated for each specific UE and informed to the UE via an RRC signaling message. This means that the UE needs to complete RRC establishment to get the information about the UE-specific search space. CSS is the search space that every UE needs to search for cell-common signals (e.g., a PDCCH for a system information block [SIB]). For example, the UE needs to detect a PDCCH for SIB1 reception and a PDCCH for random access channel (RACH) procedure (e.g., DCI for Msg2/Msg4 reception). Different types of PDCCH are monitored in a CSS. A Type0-PDCCH configured by searchSpaceSIB1 is used to schedule SIB1, a TypeOA-PDCCH configured by searchSpaceOtherSystemInformation is used to schedule other SIBs, a Type1-PDCCH configured by ra-SearchSpace is used to schedule Msg2 and Msg4 in a RACH procedure, and a Type-2 PDCCH configured by pagingSearchSpace and peiSearchSpace is used to schedule paging early indication (PEI) and Paging messages.

For PDSCH repetition, aggregation of multiple slots with Transport Block (TB) repetition is supported. The PDCCH repetition is operated by using two search spaces which are explicitly linked by configuration provided by the RRC layer, and are associated with corresponding CORESETs. For PDCCH repetition, two linked search spaces are configured with the same number of candidates, and two PDCCH candidates in two search spaces are linked with the same candidate index. When PDCCH repetition is scheduled to a UE, an intra-slot repetition is allowed and each repetition has the same number of CCEs and coded bits, and corresponds to the same DCI payload. PDCCH repetition by linking two common search spaces is not presently supported for a Type0-PDCCH configured by searchSpaceSIB1, Type0A-PDCCH configured by searchSpaceOtherSystemInformation, Type1-PDCCH configured by ra-SearchSpace, and Type-2 PDCCH configured by pagingSearchSpace and peiSearchSpace.

Repetition is also supported in multi-TRP operation. There are presently two different operation modes for multi-TRP PDCCH: PDCCH repetition and Single Frequency Network (SFN) based PDCCH transmission. In both modes, the UE can receive two PDCCH transmissions, one from each TRP, carrying the same DCI. In PDCCH repetition mode, the UE can receive the two PDCCH transmissions carrying the same DCI from two linked search spaces each associated with a different CORESET. In SFN based PDCCH transmission mode, the UE can receive the two PDCCH transmissions carrying the same DCI from a single search space/CORESET using different TCI states.

For RRC connection reestablishment, TN to NTN reestablishment can be supported. For example, the network can indicate an enabling indication for TN to NTN RRC connection re-establishment, for example, in UE dedicated signaling or in SI of a current cell or in a SIB1 of the selected cell for RRC reestablishment. The UE can select NTN cell for RRC connection reestablishment, if the UE has NTN-specific assistance information acquired from the current cell and/or if TN to NTN RRC connection re-establishment is enabled and/or if the UE supports TN to NTN RRC connection reestablishment.

To improve DL coverage, repetition for PDCCH scheduling common signalling and PDSCH repetition for SIB1 and Msg4 are considered. Various embodiments of the present disclosure provide relevant UE capabilities, configuration signalling and UE procedures for PDCCH/PDSCH repetition.

To improve DL coverage, PDCCH repetition for CSS is considered. Various embodiments of the present disclosure provide UE procedures for PDCCH repetition for CSS. For example, in some embodiments, PDCCH repetition in CSS can be supported for PDCCH for SIB1, and/or PDCCH for other SIBs, and/or PDCCH for Msg2 in an RA procedure, and/or PDCCH for Msg4 in an RA procedure, and/or PDCCH for paging, and/or PDCCH for PEI.

In some embodiments, the network (NW) transmits a PDCCH repetition enabling indication and/or PDCCH repetition configuration. In embodiments such as these, the PDCCH repetition enabling indication and/or PDCCH repetition configuration can be pre-defined and/or transmitted in system information (e.g., the master information block [MIB] or SIB1) and/or in UE dedicated RRC signalling. In some embodiments, The PDCCH repetition enabling indication can be explicitly indicated by a one-bit RRC parameter or implicitly indicated by the PDCCH repetition configuration. In some embodiments, the UE receives the PDCCH repetition enabling indication and/or PDCCH repetition configuration and receives PDCCH repeatedly based on the PDCCH repetition enabling indication and/or the PDCCH repetition configuration.

As an example, the PDCCH repetition configuration can be included in SIB1 (e.g., in PDCCH-ConfigCommon). The PDCCH repetition configuration can include a new list of CSSs such that the maximum number of CSSs per cell can be extended from 4 (i.e., 4 is the current max number of CSS per cell) to X, where X can be an integer from 5, 6, 7, or 8. The PDCCH repetition configuration can include a search space linking ID which is used to link two CSSs. If two CSSs have the same search space linking ID, the UE assumes these CSSs are linked for PDCCH repetition.

In some embodiments, for Type0-PDCCH repetition for SIB1, two CSSs (e.g., the existing CSS which is identified by searchSpaceSIB1, and a new CSS in the same BWP, e.g., identified by searchSpaceSIB1-2) can be linked by a search space linking ID. In embodiments such as these, the UE monitors and/or detects Type0-PDCCH on both CSSs. searchSpaceSIB1-2 indicates the ID of the second search space for SIB1 message. In the initial DL BWP of the UE's PCell, the network sets this field to 0. If the field is absent, the UE does not receive SIB1 in this BWP. In some embodiments, this field is absent for the reduced capability (RedCap)-specific initial DL BWP, if it does not include a cell defining (CD)-SSB and the entire CORESET #0. In that case, a RedCap or enhanced RedCap (eRedCap) UE in an RRC_IDLE or RRC INACTIVE state shall monitor the PDCCH to receive SIB1 using searchSpaceSIB1 in the initial DL BWP that includes the CD-SSB and the entire CORESET #0.

In some embodiments, for Type0A-PDCCH repetition for other SIBs, two CSSs, (e.g., the existing CSS which is identified by searchSpaceOtherSystemInformation, and a new CSS in the same BWP, e.g., identified by searchSpaceOtherSystemInformation2) can be linked by a search space linking ID. In embodiments such as these, the UE monitors and/or detects Type0A-PDCCH on both CSSs. searchSpaceOtherSystemInformation2 indicates the ID of the search space linked to the search space indicated by searchSpaceOtherSystemInformation for other system information, (i.e., SIB2 and beyond). In some embodiments, this field is present only if a search space linking ID is configured for the search space indicated by searchSpaceOtherSystemInformation, it is absent otherwise.

In some embodiments, for Type1-PDCCH repetition for Msg2/4, two CSSs, (e.g., the existing CSS which is identified by ra-SearchSpace, and a new CSS in the same BWP, e.g., identified by ra-SearchSpace2), can be linked by a search space linking ID. In embodiments such as these, the UE monitors and/or detects Type1-PDCCH on both CSSs. ra-SearchSpace2 indicates the ID of the search space linked to the search space indicated by ra-SearchSpace for random access procedure. In some embodiments, this field is present only if a search space linking ID is configured for the search space indicated by ra-SearchSpace, and is absent otherwise.

In some embodiments, for paging, the UE monitors one paging occasion (PO) per DRX cycle. A PO is a set of PDCCH monitoring occasions and can include multiple time slots (e.g., subframes or OFDM symbols) where a paging DCI can be sent. One Paging Frame (PF) is one Radio Frame and may contain one or multiple PO(s) or starting points of a PO. The PF and PO for paging are determined by the following formulas: SFN for the PF is determined by (SFN+PF_offset) mod T=(T div N)*(UE_ID mod N); Index (i_s), indicating the index of the PO UE is required to monitor, is determined by i_s=floor (UE_ID/N) mod Ns.

In some embodiments, for Type2-PDCCH repetition for paging, two CSSs, (e.g., the existing CSS which is identified by pagingSearchSpace, and a new CSS in the same BWP, e.g., identified by pagingSearchSpace2) can be linked by a search space linking ID. In embodiments such as these, the UE monitors and/or detects Type2-PDCCH for paging on both CSSs. pagingSearchSpace2 indicates the ID of the search space linked to the search space indicated by pagingSearchSpace for paging. In some embodiments, this field is present only if a search space linking ID is configured for the search space indicated by ra-SearchSpace, and is absent otherwise.

In some embodiments, if two CSSs for paging are linked by a search space linking ID, the PDCCH monitoring occasions for paging are determined according to the two linked CSS, pagingSearchSpace and pagingSearchSpace2 and firstPDCCH-MonitoringOccasionOfPO and nrofPDCCH-MonitoringOccasionPerSSB-InPO if configured. In embodiments such as these, when SearchSpaceId=0 is configured for pagingSearchSpace and/or pagingSearchSpace2, the PDCCH monitoring occasions for paging are same as for SIB1. When SearchSpaceId=0 is configured for pagingSearchSpace and/or pagingSearchSpace2, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF. When SearchSpaceId other than 0 is configured for pagingSearchSpace and/or pagingSearchSpace2, the UE monitors the (i_s+1)^{th} PO.

In some embodiments, for PEI, the UE monitors one PEI occasion per DRX cycle. A PEI occasion (PEI-O) is a set of PDCCH monitoring occasions (MOs) and can include multiple time slots (e.g., subframes or OFDM symbols) where a PEI can be sent). In some embodiments, in multi-beam operations, the UE assumes that the same PEI is repeated in all transmitted beams and thus the selection of the beam(s) for the reception of the PEI is up to UE implementation. In some embodiments, the time location of PEI-O for UE's PO is determined by a reference point and an offset. In embodiments such as these, the reference point is the start of a reference frame determined by a frame-level offset from the start of the first PF of the PF(s) associated with the PEI-O, provided by pei-FrameOffset in SIB1. The offset is a symbol-level offset from the reference point to the start of the first PDCCH MO of this PEI-O, provided by firstPDCCH-MonitoringOccasionOfPEI-O in SIB1.

In some embodiments, for Type2-PDCCH repetition for PEI, two CSSs (e.g., the existing CSS which is identified by pei-SearchSpace, and a new CSS in the same BWP, e.g., identified by pei-SearchSpace2) can be linked by a search space linking ID. In embodiments such as these, the UE monitors and/or detects Type2-PDCCH for PEI on both CSSs. pei-SearchSpace2 indicates the ID of search space linked to the search space indicated by pei-SearchSpace for PEI. In some embodiments, this field is present only if a search space linking ID is configured for the search space indicated by pei-SearchSpace, and is absent otherwise. pei-SearchSpace can be configured to one of the CSSs configured by commonSearchSpaceList with SearchSpaceId>0. SearchSpaceId=0 can be configured for the case of SS/PBCH block and CORESET multiplexing pattern 2 or 3.

In some embodiments, if two CSSs for PEI are linked by a search space linking ID, the PDCCH MOs for PEI are determined according to pei-SearchSpace, pei-SearchSpace2, pei-FrameOffset, firstPDCCH-MonitoringOccasionOfPEI-O and nrofPDCCH-MonitoringOccasionPerSSB-InPO if configured. In embodiments such as these, when SearchSpaceId=0 is configured for pei-SearchSpace and/or pei-SearchSpace2, the PDCCH MOs for PEI are same as for SIB1. When SearchSpaceId=0 is configured for pei-SearchSpace and/or pei-SearchSpace2, the UE monitors the PEI-O according to searchSpaceZero. The UE determines first PDCCH MO for PEI-O based on pei-FrameOffset and firstPDCCH-MonitoringOccasionOfPEI-O, as for the case with SearchSpaceId>0 configured. When SearchSpaceId other than 0 is configured for pei-SearchSpace and/or pei-SearchSpace2, the UE monitors the PEI-O according to the search space with the configured SearchSpaceId.

In some embodiments, the PDCCH repetition configuration in SIB1 can include a repetition number R, which indicates the number of repeated PDCCH. In embodiments such as these, the PDCCH repetition configuration in SIB1 can implicitly indicate the enabling of PDCCH repetition. The repetition number R can indicate the number of PDCCH monitoring occasions to be monitored repeatedly. In one example, R is a fixed value signaled by the NW. In another example, the value of R depends on the measured RSRP of the current serving cell UE camped on. The mapping between the value of R and the value of measured RSRP can be signaled. A larger value of measured RSRP can be mapped to a smaller value of R.

In some embodiments, for RA procedure, if R (e.g., indicating the number of PDCCH monitoring occasions to be monitored repeatedly for Msg2/4) is signaled, a UE capable of receiving PDCCH repetitions for Msg2/4 monitors and/or detects (e.g., combines and decodes) R PDCCH monitoring occasions on the search space indicated by ra-SearchSpace.

In some embodiments, for paging, if R (e.g., indicating the number of PDCCH repetition for paging, and/or the number of PDCCH monitoring occasions to be monitored repeatedly) is signaled, a UE capable of receiving PDCCH repetitions for paging monitors and/or detects (e.g., combines and decodes) R PDCCH monitoring occasions for the same PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the Kth transmitted SSB, where X=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. In one example, the UE chooses R PDCCH monitoring occasions according to implementation starting from the first PDCCH monitoring occasion in its PO. In another example, the UE monitors R consecutive PDCCH monitoring occasions from the first PDCCH monitoring occasion in its PO which is the (i_s+1)^{th} PO. In a third example, if nrofPDCCH-MonitoringOccasionPerSSB-InPO is configured, the UE selects one SSB from the S transmitted SSBs and monitors min (R, X) PDCCH monitoring occasions among the X PDCCH monitoring occasions of the selected SSB. If X>1 and if R is not configured, when the UE detects a PDCCH transmission addressed to a P-RNTI within its PO, the UE is not required to monitor the subsequent PDCCH monitoring occasions for this PO.

In some embodiments, for PEI, if R (e.g., indicating the number of PDCCH repetitions for PEI, and/or the number of PDCCH monitoring occasions to be monitored repeatedly) is signaled, a UE capable of receiving PDCCH repetitions for PEI monitors and/or detects (e.g., combines and decodes) R PDCCH monitoring occasions for its PEI-O. In embodiments such as these, if R is not configured, when the UE detects a PEI within its PEI-O, the UE is not required to monitor and/or detect (e.g., combine and decode) the subsequent MO(s) associated with the same PEI-O. A PEI occasion is a set of ‘S*X’ consecutive PDCCH MOs, where ‘S’ is the number of actual transmitted SSBs determined according to ssb-PositionsInBurst in SIB1, and X is the nrofPDCCH-MonitoringOccasionPerSSB-InPO if configured or is equal to 1 otherwise. The [x*S+K]^{th} PDCCH MO for PEI in the PEI-O corresponds to the Kth transmitted SSB, where x=0, 1, . . . , X−1, K=1, 2, . . . , S. The PDCCH MOs for PEI which do not overlap with UL symbols (determined according to tdd-UL-DL-ConfigurationCommon) are sequentially numbered from zero starting from the first PDCCH MO for PEI in the PEI-O. In one example, a UE according to implementation chooses R PDCCH monitoring occasions to monitor for its PEI-O, starting from the first PDCCH monitoring occasion in its PEI-O. In another example, the UE monitors R consecutive PDCCH monitoring occasions from the first PDCCH monitoring occasion in its PEI-O. In a third example, if nrofPDCCH-MonitoringOccasionPerSSB-InPO is configured, the UE selects one SSB from the S transmitted SSBs and monitors min (R, X) PDCCH monitoring occasions among the X PDCCH monitoring occasions of the selected SSB.

In some embodiments, PDCCH repetition for beam failure recovery (BFR) is provided. In embodiments such as these, for PDCCH repetition for BFR, two search spaces, e.g., the existing search space, which is identified by recoverySearchSpaceId, and a new SS in the same BWP, (e.g., identified by recoverySearchSpaceId2), can be linked by a search space linking ID. The UE monitors and/or detects (e.g., combine and decodes) PDCCH for BFR RAR on both SSs. recoverySearchSpaceId2 indicates the ID of search space linked to the search space indicated by recoverySearchSpaceId for BFR. The network configures this search space to be within the linked DL BWP (i.e., within the DL BWP with the same bwp-Id) of the UL BWP in which the BeamFailureRecoveryConfig is provided. In some embodiments, this field is present only if a search space linking ID is configured for the search space indicated by recoverySearchSpaceId, and is absent otherwise.

For example, in some embodiments, if the contention-free Random Access Preamble for beam failure recovery request was transmitted by the MAC entity, if recoverySearchSpaceId2 is configured, the UE monitors and/or detects (e.g., combines and decodes) for a PDCCH transmission on the search space indicated by recoverySearchSpaceId and recoverySearchSpaceId2 of the SpCell identified by the C-RNTI while ra-ResponseWindow is running. In embodiments such as these, if recoverySearchSpaceId2 is not configured, the UE monitors for a PDCCH transmission on the search space indicated by recoverySearchSpaceId of the SpCell identified by the C-RNTI while ra-Response Window is running.

In some embodiments, if notification of a reception of a PDCCH transmission on the search space indicated by recoverySearchSpaceId or recoverySearchSpaceId2 is received from lower layers on the Serving Cell where the preamble was transmitted, and if PDCCH transmission is addressed to the C-RNTI, and if the contention-free Random Access Preamble for beam failure recovery request was transmitted by the MAC entity, the UE considers the Random Access procedure successfully completed. In some embodiments, If ra-Response Window configured in BeamFailureRecoveryConfig expires and if a PDCCH transmission neither on the search space indicated by recoverySearchSpaceId addressed to the C-RNTI nor on the search space indicated by recoverySearchSpaceId2 addressed to the C-RNTI has not been received on the Serving Cell where the preamble was transmitted, the UE considers the Random Access Response reception not successful.

In some embodiments, for beam failure recovery (BFR), if R (e.g., indicating the number of PDCCH monitoring occasions to be monitored repeatedly) is signaled, a UE capable of receiving PDCCH repetitions for BFR monitors and/or detects (e.g., combines and decodes) R PDCCH monitoring occasions on the search space indicated by recoverySearchSpaceId.

In some embodiments, PDCCH repetition for Multicast Broadcast Service (MBS) is provided. For PDCCH repetition for MBS MCCH, two common search spaces, (e.g., the existing CSS which is identified by searchSpaceMCCH (searchSpaceMulticastMCCH), and a new CSS in the same BWP, e.g., identified by searchSpaceMCCH2 (searchSpaceMulticastMCCH2)), can be linked by a search space linking ID. In embodiments such as these, the UE monitors and/or detects (e.g., combines and decodes) PDCCH for MBS MCCH on both CSSs. searchSpaceMCCH2 (searchSpaceMulticastMCCH2) indicates the ID of search space linked to the search space indicated by searchSpaceMCCH (searchSpaceMulticastMCCH) for MBS. If searchspaceMCCH2 (searchSpaceMulticastMCCH2) is set to zero, PDCCH monitoring occasions for MCCH message reception in the MCCH transmission window are the same as PDCCH monitoring occasions for SIB1. If searchspaceMCCH2 (searchSpaceMulticastMCCH2) is not set to zero, PDCCH monitoring occasions for MCCH message are determined based on search space indicated by searchspaceMCCH2 (searchSpaceMulticastMCCH2).

In some embodiments, for PDCCH repetition for MBS MTCH, two common search spaces (e.g., the existing CSS which is identified by searchSpaceMTCH (searchSpaceMulticastMTCH), and a new CSS in the same BWP, e.g., identified by searchSpaceMTCH2 (searchSpaceMulticastMTCH2)) can be linked by a search space linking ID. In embodiments such as these, the UE monitors and/or detects (e.g., combine and decodes) the PDCCH for MBS MTCH on both CSSs. searchSpaceMTCH2 (searchSpaceMulticastMTCH2) indicates the ID of search space linked to the search space indicated by searchSpaceMTCH f (searchSpaceMulticastMTCH) or MBS.

In some embodiments, PDCCH repetition for Small Data Transmission (SDT) is provided. For PDCCH repetition for SDT, two common search spaces (e.g., the existing CSS which is identified by sdt-SearchSpace, and a new CSS in the same BWP, e.g., identified by sdt-SearchSpace2) can be linked by a search space linking ID. In embodiments such as these, the UE monitors and/or detects (e.g., combines and decodes) the PDCCH for SDT on both CSSs. sdt-SearchSpace2 indicates the ID of search space linked to the search space indicated by sdt-SearchSpace for SDT.

In some embodiments, a UE capability of supporting the repetition of PDCCH for SIB1, and/or a UE capability of supporting repetition of PDCCH for other SIBs, and/or a UE capability of supporting repetition of PDCCH for Msg2 in RACH procedure, and/or a UE capability of supporting repetition of PDCCH for Msg4 in RACH procedure, and/or a UE capability of supporting repetition of PDCCH for PEI, and/or a UE capability of supporting repetition of PDCCH for paging, and/or a UE capability of supporting repetition of PDCCH for BFR RAR, and/or a UE capability of supporting repetition of PDCCH for MBS MCCH/MTCH, and/or a UE capability of supporting repetition of PDCCH for SDT, can be defined. For example, one or more of these UE capabilities can be signalled per UE or per frequency band or per frequency band combination, differentiated or not differentiated between FDD and TDD system, and/or between FR1 and FR2. As an example, in some embodiments, one or more capabilities can be applicable only if the UE supports an NTN. In another example, in some embodiments, the UE reports one or more capabilities in an RRC message (e.g., a UE capability information message) as a response to a UE capability inquiry sent by the NW.

In some embodiments, a UE capability of the supported number of repetitions of PDCCH for SIB1, and/or a UE capability of the supported number of repetitions of PDCCH for other SIBs, and/or a UE capability of the supported number of repetitions of PDCCH for Msg2 in RACH procedure, and/or a UE capability of the supported number of repetitions of PDCCH for Msg4 in RACH procedure, and/or a UE capability of the supported number of repetitions of PDCCH for PEI, and/or a UE capability of the supported number of repetitions of PDCCH for paging, and/or a UE capability of the supported number of repetitions of PDCCH for BFR RAR, and/or a UE capability of the supported number of repetitions of PDCCH for MBS MCCH/MTCH, and/or a UE capability of the supported number of repetitions of PDCCH for SDT, can be defined. One or more of these UE capabilities can be signalled per UE or per frequency band or per frequency band combination, differentiated or not differentiated between FDD and TDD system, and/or between FR1 and FR2. As an example, in some embodiments, one or more capabilities can be applicable only if UE supports NTN. In another example, in some embodiments, the UE reports one or more capabilities in an RRC message (e.g., a UE capability information message) as a response to a UE capability inquiry sent by the NW.

In some embodiments, a UE capability of supporting the repetition of PDSCH for SIB1 (e.g., within the shortest periodicity which can be 20 ms), and/or a UE capability of the supported number of repetitions of PDSCH for SIB1 (e.g., within the shortest periodicity which can be 20 ms) can be defined. In embodiments such as these, one or more of these UE capabilities can be signalled per UE or per frequency band or per frequency band combination, differentiated or not differentiated between FDD and TDD system, and/or between FR1 and FR2. As an example, in some embodiments, one or more capabilities can be applicable only if UE supports NTN. In another example, The UE reports one or more capabilities in an RRC message (e.g., a UE capability information message) as a response to a UE capability inquiry sent by the NW.

In some embodiments, in a 4-step Random Access (RA) procedure Msg4, a PDSCH can be transmitted from base station (BS) repeatedly to improve DL coverage. In some embodiments, when a UE performs an RA procedure for initial access to a cell, Message 4 (Msg4) PDSCH repetition is enabled automatically, and a UE capable of receiving Msg4 PDSCH repetitions includes a request/capability indication for Msg4 PDSCH repetition in the Message 3 (Msg3).

In some embodiments, the NW enables Msg4 PDSCH repetition by transmitting a configuration for Msg4 PDSCH repetition in system information or in UE dedicated signaling (e.g., an RRC message). In embodiments such as these, ff Msg4 PDSCH repetition is enabled, a UE capable of receiving Msg4 PDSCH repetitions includes a request/capability indication for Msg4 PDSCH repetition in the Msg3 when the UE performs an RA procedure. In some embodiments, the configuration of Msg4 PDSCH repetition can be per RACH configuration or per BWP or per Cell in a SIB or in RRC message. In some embodiments, the configuration for PUCCH repetition for Msg4 HARQ-ACK (i.e., a repetition number and a RSRP threshold in SIB19) can be used for Msg4 PDSCH repetition commonly.

In some embodiments, the configuration of Msg4 PDSCH repetition includes an explicit one-bit enabling indication. Alternatively, the configuration of Msg4 PDSCH repetition can include one or multiple repetition numbers which implicitly indicate the enabling of Msg4 PDSCH repetition. For instance, in some embodiments a bit string of L bits can used to indicate the repetition number. Each bit can indicate a repetition number and at most L repetition numbers can be indicated. The repetition number 1 shall be indicated together with at least one other repetition number. Alternatively, in some embodiments, a list of integers can be enumerated to indicate the repetition number(s).

In some embodiments, the configuration of Msg4 PDSCH repetition can include one threshold (e.g., an RSRP threshold). In embodiments such as these, the threshold is used to determine whether Msg4 PDSCH repetition is enabled or not. For instance, in some embodiments, if the RSRP of a DL reference signal is smaller than the threshold, Msg4 PDSCH repetition is enabled.

In some embodiments, the configuration of Msg4 PDSCH repetition can include one or more threshold(s) (e.g., RSRP threshold). In embodiments such as these, each threshold can be mapped to a repetition number. The thresholds are used to determine whether Msg4 PDSCH repetition is enabled or not. For instance, in some embodiments, if the RSRP of a DL reference signal is smaller than a threshold A and threshold A is the smallest among the configured thresholds that is larger than the RSRP of DL reference signal, Msg4 PDSCH repetition is enabled and the repetition number that is mapped to threshold A is used.

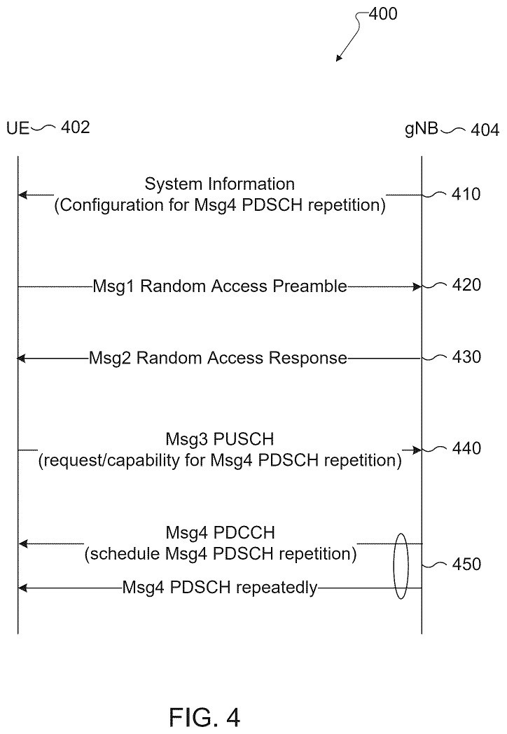

FIG. 4 illustrates an example procedure for 4-step CBRA with a Msg3 including a request/capability for Msg4 PDSCH repetition 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for 4-step CBRA with a Msg3 including a request/capability for Msg4 PDSCH repetition could be used without departing from the scope of this disclosure.

In the example of FIG. 4, the procedure 400 begins at operation 410. At operation 410, a UE 402 receives system information from a gNB 404. The system information includes a configuration for Msg4 PDSCH repetition.

At operation 420, the UE 402 transmits a Msg1 RA preamble to gNB 404, and at operations 430, the UE 402 receives a Msg2 RAR transmitted from the gNB 404 which includes an UL grant for a Msg3.

At operation 440, the UE 402 transmits a Msg3 MAC PDU using the UL grant. If Msg4 PDSCH repetition is enabled, if the UE 402 is capable of receiving Msg4 PDSCH repetitions, UE 402 transmits a Msg3 MAC PDU that includes a request/capability for Msg4 PDSCH repetition.

After transmitting the Msg3, at operation 450, the UE 402 receives a Msg4 transmitted from the BS. Based on the request/capability included in the Msg3, the network may indicate a number of Msg4 PDSCH repetitions and schedule the repeated Msg4 PDSCH transmissions in the DCI carried in the Msg4 PDCCH. If Msg4 PDSCH repetition is indicated/scheduled by the DCI Msg4 PDCCH, the UE receives repeated Msg4 PDSCH accordingly.

Although FIG. 4 illustrates one example procedure for 4-step CBRA with a Msg3 including a request/capability for Msg4 PDSCH repetition 400, various changes may be made to FIG. 4. For example, while shown as a series of operations, various operations in FIG. 4 could overlap, occur in parallel, occur in a different order, occur any number of times, be omitted, or replaced by other operations.

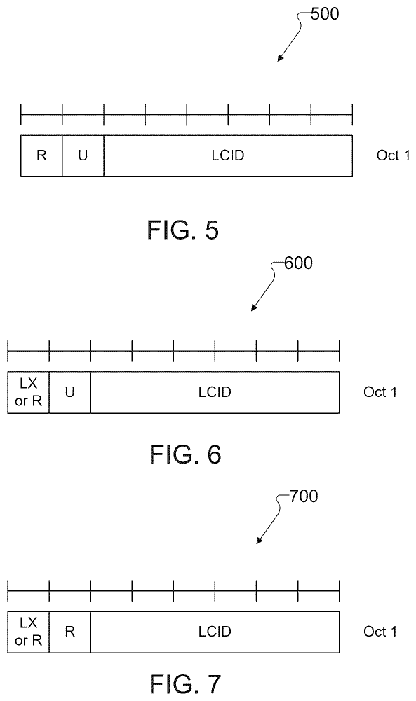

FIGS. 5-7 illustrate example MAC subheaders 500-700 according to embodiments of the present disclosure. The embodiments of MAC subheaders of FIGS. 500-700 are for illustration only. Different embodiments of a MAC subheader could be used without departing from the scope of this disclosure.

FIG. 5 shows a MAC subheader 500 of a C-RNTI MAC CE where a 1st or 2nd Reserved bit in the MAC subheader is repurposed, denoted as the “U” field.

FIG. 6 shows a MAC subheader 600 of a UL CCCH/CCCH1 MAC SDU where a reserved bit in the MAC subheader is repurposed, denoted as the “U” field.

FIG. 7 shows a MAC subheader 700 of a UL CCCH/CCCH1 MAC SDU.

Although FIGS. 5-7 illustrate examples of MAC subheaders 500-700, various changes may be made to FIGS. 5-7. For example, various changes to reserved bits could be made, etc. according to particular needs.

In some embodiments, in a 4-step CBRA procedure, a request/capability for Msg4 PDSCH repetition can be included in the Msg3 as follows:
If a C-RNTI MAC CE is included in the Msg3 MAC PDU:
   a 1^{st} or 2^{nd} Reserved bit in MAC subheader of the C-RNTI MAC CE is repurposed as shown in FIG. 5, where the denoted U field is set to 1 to indicate the request/capability for Msg4 PDSCH repetition; or
If a UL CCCH/CCCH1 MAC SDU is included in the Msg3 MAC PDU (a CCCH of size 48 bits and CCCH of size 64 bits are referred to as CCCH and CCCH1, respectively):
   one bit in the UL CCCH/CCCH1 message or one bit within the RRC setup/resume/reestablishment/systemInfo request message included in UL CCCH/CCCH1 message is used to indicate the request/capability for Msg4 PDSCH repetition; or
   a Reserved bit in MAC subheader of UL CCCH/CCCH1 MAC SDU is repurposed as shown in FIG. 6., where the denoted U field is set to 1 to indicate the request/capability for Msg4 PDSCH repetition.
   in the MAC subheader for UL CCCH/CCCH1 MAC SDU, as shown in FIG. 7, the LX field is set to 1 and the LCID field is set to a value in Table 1 below. The LCID indicates the request/capability for Msg4 PDSCH repetition, where X1, X2, X3, X4, X5, X6, Z1, Z2, Z3, Z4, Z5, Z6 are integers smaller than 63, Y1, Y2, Y3, Y4, Y5, Y6, W1, W2, W3, W4, W5, W6 are integers between (216+328) and (216+383). LCID is the Logical Channel Identification (ID) that identifies the logical channel instance of the corresponding MAC SDU or the type of the corresponding MAC CE or padding for the DL-SCH and for the UL-SCH. LX is the LCID extension field that indicates the use of extended LCID space. The size of the LX field is 1 bit. The LX field set to 1 indicates the use of Table 1. Otherwise, an R bit is present instead (i.e., the bit is set to 0).

TABLE 1
Values of LCID for UL-SCH when the LX field is set to 1

| Codepoint | Index | LCID values |
|---|---|---|
| 0 | (2¹⁶ + 320) | CCCH of size 48 bits for an eRedCap UE |
| 1 | (2¹⁶ + 321) | CCCH of size 64 bits for an eRedCap UE |
| 2 | (2¹⁶ + 322) | CCCH of size 48 bits for PUCCH repetition |
| | | of Msg4 HARQ-ACK, except for an |
| | | (e)RedCap UE |
| 3 | (2¹⁶ + 323) | CCCH of size 64 bits for PUCCH repetition |
| | | of Msg4 HARQ-ACK, except for an |
| | | (e)RedCap UE |
| 4 | (2¹⁶ + 324) | CCCH of size 48 bits for PUCCH repetition |
| | | of Msg4 HARQ-ACK of a RedCap UE |
| 5 | (2¹⁶ + 325) | CCCH of size 64 bits for PUCCH repetition |
| | | of Msg4 HARQ-ACK of a RedCap UE |
| 6 | (2¹⁶ + 326) | CCCH of size 48 bits for PUCCH repetition |
| | | of Msg4 HARQ-ACK of an eRedCap UE |
| 7 | (2¹⁶ + 327) | CCCH of size 64 bits for PUCCH repetition |
| | | of Msg4 HARQ-ACK of an eRedCap UE |
| X1 | Y1 | CCCH of size 48 bits for Msg4 PDSCH |
| | | repetition, except for an (e)RedCap UE |
| X2 | Y2 | CCCH of size 64 bits for Msg4 PDSCH |
| | | repetition, except for an (e)RedCap UE |
| X3 | Y3 | CCCH of size 48 bits for Msg4 PDSCH |
| | | repetition of a RedCap UE |
| X4 | Y4 | CCCH of size 64 bits for Msg4 PDSCH |
| | | repetition of a RedCap UE |
| X5 | Y5 | CCCH of size 48 bits for Msg4 PDSCH |
| | | repetition of an eRedCap UE |
| X6 | Y6 | CCCH of size 64 bits for Msg4 PDSCH |
| | | repetition of an eRedCap UE |
| Z1 | W1 | CCCH of size 48 bits for Msg4 PDSCH |
| | | repetition and/or PUCCH repetition |
| | | of Msg4 HARQ-ACK, except for |
| | | an (e)RedCap UE |
| Z2 | W2 | CCCH of size 64 bits for Msg4 PDSCH |
| | | repetition and/or PUCCH repetition |
| | | of Msg4 HARQ-ACK, except for |
| | | an (e)RedCap UE |
| Z3 | W3 | CCCH of size 48 bits for Msg4 PDSCH |
| | | repetition and/or PUCCH repetition |
| | | of Msg4 HARQ-ACK of a RedCap UE |
| Z4 | W4 | CCCH of size 64 bits for Msg4 PDSCH |
| | | repetition and/or PUCCH repetition |
| | | of Msg4 HARQ-ACK of a RedCap UE |
| Z5 | W5 | CCCH of size 48 bits for Msg4 PDSCH |
| | | repetition and/or PUCCH repetition |
| | | of Msg4 HARQ-ACK of an eRedCap UE |
| Z6 | W6 | CCCH of size 64 bits for Msg4 PDSCH |
| | | repetition and/or PUCCH repetition |
| | | of Msg4 HARQ-ACK of an eRedCap UE |

In some embodiments, in a 2-step Random Access (RA) procedure, a MsgB PDSCH can be transmitted from a base station (BS) repeatedly to improve DL coverage. PUCCH repetition for MsgB HARQ-ACK can be considered to improve UL coverage. In some embodiments, when a UE performs a 2-step RA procedure for initial access to a cell, MsgB PDSCH repetition is enabled automatically, and a UE capable of receiving MsgB PDSCH repetitions includes the request/capability indication for MsgB PDSCH repetition in MsgA.

In some embodiments, the NW enables MsgB PDSCH repetition by transmitting a configuration for Msg4 PDSCH repetition in system information or in UE dedicated signaling (e.g., an RRC message). In embodiments such as these, if MsgB PDSCH repetition is enabled, a UE capable of receiving MsgB PDSCH repetitions includes a request/capability indication for MsgB PDSCH repetition in MsgA when the UE performs an RA procedure. In some embodiments, the configuration of MsgB PDSCH repetition can be per RACH configuration or per BWP or per Cell in SIB or in RRC message. I some embodiments, the configuration for MsgB PDSCH repetition can be used for PUCCH repetition for MsgB HARQ-ACK commonly.

In some embodiments, the configuration of MsgB PDSCH repetition can include an explicit one-bit enabling indication. Alternatively, in some embodiments, the configuration of MsgB PDSCH repetition can include one or multiple repetition numbers which implicitly indicate the enabling of MsgB PDSCH repetition. For instance, in some embodiments, a bit string of L bits can be used to indicate the repetition number. In examples such as these, each bit can indicate a repetition number and at most L repetition numbers can be indicated. The repetition number 1 shall be indicated together with at least one other repetition number. Alternatively, in some embodiments, a list of integers can be enumerated to indicate the repetition number(s).

In some embodiments, the configuration of MsgB PDSCH repetition can include one threshold (e.g., an RSRP threshold). In embodiments such as these, the threshold can be used to determine whether MsgB PDSCH repetition is enabled or not. For instance, in some embodiments, if the RSRP of a DL reference signal is smaller than the threshold, MsgB PDSCH repetition is enabled.

In some embodiments, the configuration of MsgB PDSCH repetition can include one or more threshold(s) (e.g., an RSRP threshold). In embodiments such as these, each threshold can be mapped to a repetition number. In some embodiments, the thresholds are used to determine whether MsgB PDSCH repetition is enabled. For example, in some embodiments, if the RSRP of a DL reference signal is smaller than threshold B and threshold B is the smallest among the configured thresholds that is larger than the RSRP of DL reference signal, MsgB PDSCH repetition is enabled and the repetition number that is mapped to threshold B is used.

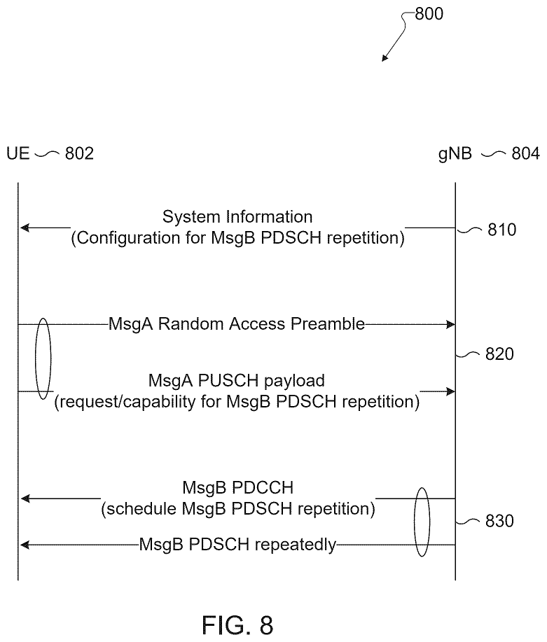

FIG. 8 illustrates an example procedure for 2-step CBRA with MsgB PDSCH repetition 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for 2-step CBRA with MsgB PDSCH repetition could be used without departing from the scope of this disclosure.

In the example of FIG. 8, the procedure 800 begins at operation 810. At operation 810, a UE 802 receives system information from a gNB 804. The system information includes a configuration for MsgB PDSCH repetition.

At operation 820, the UE 802 transmits a MsgA RA preamble and MsgA PUSCH payload containing a MAC PDU. If MsgB PDSCH repetition is enabled, and UE 802 is capable of receiving MsgB PDSCH repetitions, then UE 802 transmits a MsgA MAC PDU that includes a request/capability indication for MsgB PDSCH repetition.

At operation 830, after transmitting MsgA, UE802 receives a MsgB including a success RAR. Based on the request/capability included in the MsgA, the network may indicate a number of MsgB PDSCH repetitions and schedule the repeated MsgB PDSCH transmissions in the DCI carried in the MsgB PDCCH. If the MsgB PDSCH repetition is indicated/scheduled by DCI in MsgB PDCCH, the UE receives the repeated MsgB PDSCH transmissions accordingly.

Although FIG. 8 illustrates one example procedure for 2-step CBRA with MsgB PDSCH repetition 800, various changes may be made to FIG. 8. For example, while shown as a series of operations, various operations in FIG. 8 could overlap, occur in parallel, occur in a different order, occur any number of times, be omitted, or replaced by other operations.

In some embodiments, in a 2-step CBRA procedure, a request/capability for MsgB PDSCH repetition can be included in the MsgA as follows:
If a C-RNTI MAC CE is included in the MsgA MAC PDU:
   a Reserved bit in MAC subheader of C-RNTI MAC CE is repurposed as shown in FIG. 5, where the denoted U field is set to 1 to indicate the request/capability for MsgB PDSCH; or
If a UL CCCH/CCCH1 MAC SDU is included in the MsgA MAC PDU (a CCCH of size 48 bits and CCCH of size 64 bits are referred to as CCCH and CCCH1, respectively):
   one bit in UL CCCH/CCCH1 message or one bit within the RRC setup/resume/reestablishment/system-Info request message included in UL CCCH/CCCH1 message is used to indicate the request/capability for MsgB PDSCH repetition; or
   a Reserved bit in MAC subheader of UL CCCH/CCCH1 MAC SDU is repurposed as shown in FIG. 6, where the denoted U field is set to 1 to indicate the request/capability for MsgB PDSCH repetition; or
   in the MAC subheader for UL CCCH/CCCH1 MAC SDU, as shown in FIG. 7, the LX field is set to 1 and the LCID field is set to a value in the Table 2 below. The LCID indicates the request/capability for MsgB PDSCH repetition, where x1, x2, x3, x4, x5, x6, z1, z2, z3, z4, z5, z6, u1, u2, u3, u4, u5, u6 are integers smaller than 63, y1, y2, y3, y4, y5, y6, w1, w2, w3, w4, w5, w6, v1, v2, v3, v4, v5, v6 are integers between (216+328) and (216+383). LCID is the Logical Channel ID that identifies the logical channel instance of the corresponding MAC SDU or the type of the corresponding MAC CE or padding for the DL-SCH and for the UL-SCH. LX is the LCID extension field that indicates the use of extended LCID space. The size of the LX field is 1 bit. The LX field set to 1 indicates the use of Table 2. Otherwise, an R bit is present instead (i.e., the bit is set to 0).

TABLE 2
Values of LCID for UL-SCH when the LX field is set to 1

| Codepoint | Index | LCID values |
|---|---|---|
| x1 | y1 | CCCH of size 48 bits for MsgB PDSCH |
| | | repetition, except for an (e)RedCap UE |
| x2 | y2 | CCCH of size 64 bits for MsgB PDSCH |
| | | repetition, except for an (e)RedCap UE |
| x3 | y3 | CCCH of size 48 bits for MsgB PDSCH |
| | | repetition of a RedCap UE |
| x4 | y4 | CCCH of size 64 bits for MsgB PDSCH |
| | | repetition of a RedCap UE |
| x5 | y5 | CCCH of size 48 bits for MsgB PDSCH |
| | | repetition of an eRedCap UE |
| x6 | y6 | CCCH of size 64 bits for MsgB PDSCH |
| | | repetition of an eRedCap UE |
| z1 | w1 | CCCH of size 48 bits for MsgB PDSCH |
| | | repetition and/or PUCCH repetition |
| | | for MsgB HARQ-ACK, except for |
| | | an (e)RedCap UE |
| z2 | w2 | CCCH of size 64 bits for MsgB PDSCH |
| | | repetition and/or PUCCH repetition |
| | | for MsgB HARQ-ACK, except for |
| | | an (e)RedCap UE |
| z3 | w3 | CCCH of size 48 bits for MsgB PDSCH |
| | | repetition and/or PUCCH repetition |
| | | for MsgB HARQ-ACK of a RedCap UE |
| z4 | w4 | CCCH of size 64 bits for MsgB PDSCH |
| | | repetition and/or PUCCH repetition |
| | | for MsgB HARQ-ACK of a RedCap UE |
| z5 | w5 | CCCH of size 48 bits for MsgB PDSCH |
| | | repetition and/or PUCCH repetition |
| | | for MsgB HARQ-ACK of an eRedCap UE |
| z6 | w6 | CCCH of size 64 bits for MsgB PDSCH |
| | | repetition and/or PUCCH repetition |
| | | for MsgB HARQ-ACK of an eRedCap UE |
| u1 | v1 | CCCH of size 48 bits for PUCCH |
| | | repetition for MsgB HARQ-ACK, |
| | | except for an (e)RedCap UE |
| u2 | v2 | CCCH of size 64 bits for PUCCH |
| | | repetition for MsgB HARQ-ACK, |
| | | except for an (e)RedCap UE |
| u3 | v3 | CCCH of size 48 bits for PUCCH |
| | | repetition for MsgB HARQ-ACK |
| | | of a RedCap UE |
| u4 | v4 | CCCH of size 64 bits for PUCCH |
| | | repetition for MsgB HARQ-ACK |
| | | of a RedCap UE |
| u5 | v5 | CCCH of size 48 bits for PUCCH |
| | | repetition for MsgB HARQ-ACK |
| | | of an eRedCap UE |
| u6 | v6 | CCCH of size 64 bits for PUCCH |
| | | repetition for MsgB HARQ-ACK |
| | | of an eRedCap UE |

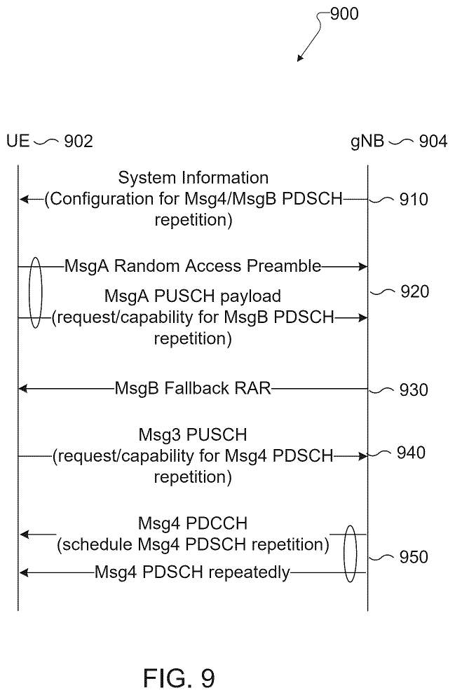

FIG. 9 illustrates an example procedure for Fallback CBRA with Msg4 PDSCH repetition 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for Fallback CBRA with Msg4 PDSCH repetition could be used without departing from the scope of this disclosure.

In the example of FIG. 9, the procedure 900 begins at operation 910. At operation 910, a UE 902 receives system information from a gNB 904. The system information includes a configuration for Msg4/MsgB PDSCH repetition.

At operation 920, UE transmits a MsgA RA preamble and MsgA PUSCH payload containing the MAC PDU. If MsgB PDSCH repetition is enabled, and UE 902 is capable of receiving MsgB PDSCH repetitions, then UE 902 transmits a MsgA MAC PDU that includes a request/capability indication for MsgB PDSCH repetition.

After transmitting the MsgA, the UE 902 receives a MsgB transmitted from the gNB 904. If UE 902 receives a fallback RAR in MsgB at operation 930, then UE 902 transmits a Msg3 MAC PDU using the UL grant included in the fallback RAR.

At operation 940, If Msg4 PDSCH repetition is enabled, and UE 902 is capable of receiving Msg4 PDSCH repetitions, UE 902 transmits a Msg3 MAC PDU that includes a request/capability for Msg4 PDSCH repetition. After transmitting the Msg3, at operation 950 the UE 902 receives a Msg4 transmitted from the gNB 904. Based on the request/capability included in the Msg3, the network may indicate a number of Msg4 PDSCH repetitions and schedule the repeated Msg4 PDSCH transmissions in the DCI carried in Msg4 PDCCH. If Msg4 PDSCH repetition is indicated/scheduled by DCI in Msg4 PDCCH, UE receives repeated Msg4 PDSCH accordingly.

Although FIG. 9 illustrates one example procedure for Fallback CBRA with Msg4 PDSCH repetition 900, various changes may be made to FIG. 9. For example, while shown as a series of operations, various operations in FIG. 9 could overlap, occur in parallel, occur in a different order, occur any number of times, be omitted, or replaced by other operations.

In some embodiments, the LCID in the MAC subheader for a UL CCCH/CCCH1 MAC SDU included in the Msg3 MAC PDU is used to indicate the request/capability for Msg4 PDSCH repetition. In embodiments such as these, when the NW configures both Msg4 PDSCH repetition and PUCCH repetition for Msg4 HARQ-ACK, one of a request/capability for Msg4 PDSCH repetition only, or a request/capability for PUCCH repetition for Msg4 HARQ-ACK only, or a request/capability for both Msg4 PDSCH repetition and PUCCH repetition for Msg4 HARQ-ACK can be transmitted in Msg3. In some embodiments, PUCCH repetition for Msg4 HARQ-ACK is enabled if numberOfMsg4HARQ-ACK-Repetitions is configured and rsrp-ThresholdMsg4HARQ-ACK is not configured, or if both are configured and the RSRP of the downlink pathloss reference is less than rsrp-ThresholdMsg4HARQ-ACK.

In some embodiments, for a UE capable of Msg4 PDSCH repetition and/or capable of PUCCH repetition for Msg4 HARQ-ACK, if Msg4 PDSCH repetition is enabled and PUCCH repetition for Msg4 HARQ-ACK is enabled, and if the UE is capable of both Msg4 PDSCH repetition and PUCCH repetition for Msg4 HARQ-ACK, the UE transmits a Msg3 MAC PDU that includes a request/capability for both Msg4 PDSCH repetition and PUCCH repetition for Msg4 HARQ-ACK. In circumstances such as these, the MAC entity uses one of the codepoints among Z1, Z2, Z3, Z4, Z5, Z6 in Table 1 for the LCID field in the MAC subheader for UL CCCH/CCCH1 MAC SDU included in the Msg3 MAC PDU. Otherwise, if Msg4 PDSCH repetition is enabled and if the UE is capable of Msg4 PDSCH repetition, the UE transmits a Msg3 MAC PDU that includes a request/capability for Msg4 PDSCH repetition only. In circumstances such as these, the MAC entity uses one of the codepoints among X1, X2, X3, X4, X5, X6 (or among Z1, Z2, Z3, Z4, Z5, Z6) in Table 1 for the LCID field in the MAC subheader for UL CCCH/CCCH1 MAC SDU included in the Msg3 MAC PDU. Otherwise, if PUCCH repetition for Msg4 HARQ-ACK is enabled and if the UE is capable of PUCCH repetition for Msg4 HARQ-ACK, the UE transmits a Msg3 MAC PDU that includes a request/capability for PUCCH repetition for Msg4 HARQ-ACK only. In circumstances such as these, the MAC entity uses one of the codepoints among 2, 3, 4, 5, 6, 7 (or among Z1, Z2, Z3, Z4, Z5, Z6) in Table 1 for the LCID field in the MAC subheader for UL CCCH/CCCH1 MAC SDU included in the Msg3 MAC PDU.

In some embodiments, for a UE capable of Msg4 PDSCH repetition and/or capable of PUCCH repetition for Msg4 HARQ-ACK, if Msg4 PDSCH repetition is enabled and if the UE is capable of Msg4 PDSCH repetition, the UE transmits a Msg3 MAC PDU that includes a request/capability for Msg4 PDSCH repetition only. In circumstances such as these, the MAC entity uses one of the codepoints among 2, 3, 4, 5, 6, 7 in Table 1 for the LCID field in the MAC subheader for UL CCCH/CCCH1 MAC SDU included in the Msg3 MAC PDU. Otherwise, if PUCCH repetition for Msg4 HARQ-ACK is enabled and if the UE is capable of PUCCH repetition for Msg4 HARQ-ACK, the UE transmits a Msg3 MAC PDU that includes a request/capability for PUCCH repetition for Msg4 HARQ-ACK only. In circumstances such as these, the MAC entity uses one of the codepoints among 2, 3, 4, 5, 6, 7 in Table 1 for the LCID field in the MAC subheader for UL CCCH/CCCH1 MAC SDU included in the Msg3 MAC PDU.

In some embodiments, the LCID in the MAC subheader for UL CCCH/CCCH1 MAC SDU included in the MsgA MAC PDU is used to indicate the request/capability for MsgB PDSCH repetition. In embodiments such as these, when the NW configures both MsgB PDSCH repetition and PUCCH repetition for MsgB HARQ-ACK, one of a request/capability for MsgB PDSCH repetition only, or a request/capability for PUCCH repetition for MsgB HARQ-ACK only, or a request/capability for both MsgB PDSCH repetition and PUCCH repetition for MsgB HARQ-ACK can be transmitted in MsgA. In some embodiments, PUCCH repetition for MsgB HARQ-ACK can be enabled by a configuration in a SIB or in a dedicated RRC message. In some embodiments, if a repetition number is configured, or if an explicit enabling indication is configured, or if a RSRP threshold is configured and the RSRP of the downlink pathloss reference is less than the RSRP threshold, or if both a repetition number is and a RSRP threshold are configured and the RSRP of the downlink pathloss reference is less than the RSRP threshold, PUCCH repetition for MsgB HARQ-ACK is considered enabled.

In some embodiments, for a UE capable of MsgB PDSCH repetition and/or capable of PUCCH repetition for MsgB HARQ-ACK, if MsgB PDSCH repetition is enabled and PUCCH repetition for MsgB HARQ-ACK is enabled and if the UE is capable of both MsgB PDSCH repetition and PUCCH repetition for MsgB HARQ-ACK, the UE transmits a MsgA MAC PDU that includes a request/capability for both MsgB PDSCH repetition and PUCCH repetition for MsgB HARQ-ACK. In circumstances such as these, the MAC entity uses one of the codepoints among z1, z2, z3, z4, z5, z6 in Table 2 for the LCID field in the MAC subheader for UL CCCH/CCCH1 MAC SDU included in the MsgA MAC PDU. Otherwise, if MsgB PDSCH repetition is enabled and if the UE is capable of MsgB PDSCH repetition, the UE transmits a MsgA MAC PDU that includes a request/capability for MsgB PDSCH repetition only. In circumstances such as these, the MAC entity uses one of the codepoints among x1, x2, x3, x4, x5, x6 (or among z1, z2, z3, z4, z5, z6) in Table 2 for the LCID field in the MAC subheader for UL CCCH/CCCH1 MAC SDU included in the MsgA MAC PDU. Otherwise, if PUCCH repetition for MsgB HARQ-ACK is enabled and if the UE is capable of PUCCH repetition for MsgB HARQ-ACK, the UE transmits a MsgA MAC PDU that includes a request/capability for PUCCH repetition for MsgB HARQ-ACK only. In circumstances such as these, the MAC entity uses one of the codepoints among u1, u2, u3, u4, u5, u6 (or among z1, z2, z3, z4, z5, z6) in Table 2 for the LCID field in the MAC subheader for UL CCCH/CCCH1 MAC SDU included in the MsgB MAC PDU.

In some embodiments, for a UE capable of MsgB PDSCH repetition and/or capable of PUCCH repetition for MsgB HARQ-ACK, if MsgB PDSCH repetition is enabled and if the UE is capable of MsgB PDSCH repetition, the UE transmits a MsgA MAC PDU that includes a request/capability for MsgB PDSCH repetition and PUCCH repetition for MsgB HARQ-ACK. In circumstance such as these, the MAC entity uses one of the codepoints among u1, u2, u3, u4, u5, u6 in Table 2 for the LCID field in the MAC subheader for UL CCCH/CCCH1 MAC SDU included in the MsgA MAC PDU. Otherwise, if PUCCH repetition for MsgB HARQ-ACK is enabled and if the UE is capable of PUCCH repetition for MsgB HARQ-ACK, the UE transmits a MsgA MAC PDU that includes a request/capability for PUCCH repetition for MsgB HARQ-ACK. In circumstances such as these, the MAC entity uses one of the codepoints among u1, u2, u3, u4, u5, u6 in Table 2 for the LCID field in the MAC subheader for UL CCCH/CCCH1 MAC SDU included in the MsgA MAC PDU.

In some embodiments, for PDCCH repetition for Msg2 in an RA procedure, the NW transmits an enabling indication and/or configuration. In embodiments such as these, the enabling indication and/or configuration can be pre-defined and/or transmitted in system information (e.g., MIB or SIB1) and/or in UE dedicated RRC signalling. In some embodiments, the enabling indication can be explicitly indicated by a one-bit RRC parameter or implicitly indicated by the PDCCH repetition configuration. In embodiments such as these, the UE receives the PDCCH repetition enabling indication and/or configuration. Accordingly, the UE monitors PDCCH repeatedly, and combines and decodes the received PDCCH repetitions.

In some embodiments, the configuration for PDCCH repetition for Msg2 can include a repetition number N1, which indicates the number of PDCCH repetitions. In embodiments such as these, the configuration can implicitly indicate the enabling of PDCCH repetition for Msg2. The repetition number N1 can indicate the number of PDCCH monitoring occasions (or PDCCH subframes/slots/symbols) to be monitored, combined and decoded. For example, in some embodiments, N1 can be a fixed value signaled by the NW. In another example, in some embodiments, the value of N1 can depend on the RSRP of a DL RS from the current serving cell the UE is camped on. The mapping between the value of N and the value of RSRP can be signaled. A larger value of RSRP can be mapped to a smaller value of N1.

In some embodiments, if N1 (e.g., indicating the number of PDCCH repetitions to be monitored/combined/decoded for Msg2) is signaled, a UE capable of supporting Msg2 PDCCH repetitions monitors and/or combines and/or decodes N1 PDCCH monitoring occasions (or PDCCH subframes/slots/symbols) on the search space indicated by ra-SearchSpace.

In some embodiments, the NW transmits multiple PDCCH monitoring occasions (or PDCCH subframes/slots/symbols) for Msg2 as configured by a RA search space. In embodiments such as these, the PDCCH monitoring occasions (or PDCCH subframes/slots/symbols) configured by the RA search space are grouped in the RAR window. Each group includes N1 PDCCH monitoring occasions (or PDCCH subframes/slots/symbols). Within a group, the UE can monitor and combine one or more or all N1 monitoring occasions (or PDCCH subframes/slots/symbols) and decode PDCCH to receive RAR. In some embodiments, the UE monitors the next group only if the RAR is not successfully received based on PDCCH monitoring occasions (or PDCCH subframes/slots/symbols) from the previous group.

In some embodiments, the NW transmits one or multiple PDCCH monitoring occasions (or PDCCH subframes/slots/symbols) for Msg2 as configured by RA search space. In embodiments such as these, in a RAR window the UE monitors a PDCCH occasion/subframe/slot/symbol as configured by RA search space, and considers it as the first PDCCH repetition. The UE then determines N1-1 additional PDCCH occasions/subframes/slots/symbols as the N1-1 PDCCH repetitions. Some embodiments, the additional N1-1 PDCCH repetitions start from the end of the first PDCCH repetition. The N1-1 PDCCH occasions/subframes/slots/symbols occur one after another in time without any gap between each two. In some embodiments, a time offset can be configured, which can be in units of a symbol/slot/subframe or in a time unit (e.g., millisecond, second, etc.). The additional N1-1 PDCCH repetitions start from the end of the first PDCCH repetition. The N1-1 PDCCH occasions/subframes/slots/symbols occur one after another in time with a gap of the configured offset between each two. In some embodiments, for the N1 PDCCH repetitions, the UE can combine one or more or all N1 repetitions (one indicated by RAR search space and N1-1 implicitly indicated) and decode PDCCH for Msg2.

In some embodiments, for PDCCH repetition for Msg4 in an RA procedure, the NW transmits an enabling indication and/or configuration. In embodiments such as these, the enabling indication and/or configuration can be pre-defined and/or transmitted in system information (e.g., MIB or SIB1) and/or in UE dedicated RRC signalling. The enabling indication can be explicitly indicated by a one-bit RRC parameter or implicitly indicated by the PDCCH repetition configuration. The UE receives the PDCCH repetition enabling indication and/or configuration. Accordingly, the UE monitors PDCCH repeatedly, and combines and decodes the received PDCCH repetitions.

In some embodiments, the configuration for PDCCH repetition for Msg4 can include a repetition number N2, which indicates the number of PDCCH repetitions. In embodiments such as these, the configuration can implicitly indicate the enabling of PDCCH repetition for Msg4. The repetition number N2 can indicate the number of PDCCH monitoring occasions (or PDCCH subframes/slots/symbols) to be monitored, combined and decoded. For example, in some embodiments, N2 can be a fixed value signaled by the NW. In another example, In some embodiments, the value of N2 can depend on the RSRP of a DL RS from the current serving cell the UE is camped on. The mapping between the value of N2 and the value of RSRP can be signaled. A larger value of RSRP can be mapped to a smaller value of N2.

In some embodiments, if N2 (e.g., indicating the number of PDCCH repetitions to be monitored/combined/decoded for Msg4) is signaled, a UE capable of supporting Msg4 PDCCH repetitions monitors and/or combines and/or decodes N2 PDCCH monitoring occasions (or PDCCH subframes/slots/symbols) on the search space indicated by ra-SearchSpace.

In some embodiments, the NW transmits multiple PDCCH monitoring occasions (or PDCCH subframes/slots/symbols) for Msg4 as configured by RA search space. In embodiments such as these, PDCCH monitoring occasions (or PDCCH subframes/slots/symbols) configured by the RA search space are grouped in the contention resolution window. Each group includes N2 PDCCH monitoring occasions (or PDCCH subframes/slots/symbols). Within a group, the UE can monitor and combine one or more or all N2 monitoring occasions (or PDCCH subframes/slots/symbols) and decode PDCCH to receive Msg4. In some embodiments, the UE monitors the next group only if Msg4 PDCCH is not successfully received based on PDCCH monitoring occasions (or PDCCH subframes/slots/symbols) from the previous group.

In some embodiments, the NW transmits one or multiple PDCCH monitoring occasions (or PDCCH subframes/slots/symbols) for Msg4 as configured by RA search space. In embodiments such as these, in the contention resolution window the UE monitors a PDCCH occasion/subframe/slot/symbol as configured by RA search space, and considers it as the first PDCCH repetition for Msg4. The UE then determines N2-1 additional PDCCH occasions/subframes/slots/symbols as the N2-1 PDCCH repetitions. For example, in some embodiments, the additional N2-1 PDCCH repetitions start from the end of the first PDCCH repetition. In embodiments such as these, the N2-1 PDCCH occasions/subframes/slots/symbols occur one after another in time without any gap between each two. In another example, in some embodiments, a time offset can be configured, which can be in units of a symbol/slot/subframe or in a time unit (e.g., millisecond, second, etc.). In embodiments such as these, the additional N2-1 PDCCH repetitions start from the end of the first PDCCH repetition for Msg4. The N2-1 PDCCH occasions/subframes/slots/symbols occur one after another in time with a gap of the configured offset between each two. For the N2 PDCCH repetitions, the UE can combine one or more or all N2 repetitions (one indicated by RAR search space and N2-1 implicitly indicated) and decode the PDCCH for Msg4.

In some embodiments, for PDCCH repetition for other system information than SIB1 (OSI), the NW transmits an enabling indication and/or configuration. In embodiments such as these, the enabling indication and/or configuration can be pre-defined and/or transmitted in system information (e.g., a MIB or SIB1) and/or in UE dedicated RRC signalling. The enabling indication can be explicitly indicated by a one-bit RRC parameter or implicitly indicated by the PDCCH repetition configuration. The UE receives the PDCCH repetition enabling indication and/or configuration. Accordingly, the UE monitors PDCCH repeatedly, and combines and decodes the received PDCCH repetitions.

In some embodiments, the configuration for PDCCH repetition for OSI can include a repetition number N3, which indicates the number of PDCCH repetitions. In embodiments such as these, the configuration can implicitly indicate the enabling of PDCCH repetition for OSI. The repetition number N3 can indicate the number of PDCCH monitoring occasions (or PDCCH subframes/slots/symbols) to be monitored, combined and decoded. For example, in some embodiments, N3 can be a fixed value signaled by the NW. In another example, in some embodiments, the value of N3 can depend on the RSRP of a DL RS from the current serving cell the UE is camped on. The mapping between the value of N3 and the value of RSRP can be signaled. A larger value of RSRP can be mapped to a smaller value of N3.

In some embodiments, if N3 (e.g., indicating the number of PDCCH repetitions to be monitored/combined/decoded for OSI) is signaled, a UE capable of supporting OSI PDCCH repetitions monitors and/or combines and/or decodes N3 PDCCH monitoring occasions (or PDCCH subframes/slots/symbols) on the search space for OSI.

In some embodiments, the NW transmits multiple PDCCH monitoring occasions (or PDCCH subframes/slots/symbols) for OSI as configured by OSI search space in an SI-window. The PDCCH monitoring occasions (or PDCCH subframes/slots/symbols) configured by the OSI search space are grouped in the SI-window. Each group includes N3 PDCCH monitoring occasions (or PDCCH subframes/slots/symbols). Within a group, UE can monitor and combine one or more or all N3 monitoring occasions (or PDCCH subframes/slots/symbols) and decode PDCCH to receive the OSI. In some embodiments, the UE monitors the next group only if OSI PDCCH is not successfully received based on PDCCH monitoring occasions (or PDCCH subframes/slots/symbols) from the previous group.

In some embodiments, the NW transmits multiple PDCCH monitoring occasions (or PDCCH subframes/slots/symbols) for OSI as configured by OSI search space in an SI-window. I embodiments such as these, the UE can monitor and combine one or more or N3 consecutive monitoring occasions (or PDCCH subframes/slots/symbols) from the start of an SI-window, and decode PDCCH to receive the OSI.

In some embodiments, the NW transmits one or multiple PDCCH monitoring occasions (or PDCCH subframes/slots/symbols) for OSI as configured by OSI search space. In embodiments such as these, in an SI-window the UE monitors a PDCCH occasion/subframe/slot/symbol as configured by OSI search space, and considers it as the first PDCCH repetition for OSI. The UE then determines N3-1 additional PDCCH occasions/subframes/slots/symbols as the N3-1 PDCCH repetitions. For example, in some embodiments, the additional N3-1 PDCCH repetitions start from the end of the first PDCCH repetition. The N3-1 PDCCH occasions/subframes/slots/symbols occur one after another in time without any gap between each two. In another example, in some embodiments, a time offset can be configured, which can be in units of a symbol/slot/subframe or in a time unit (e.g., millisecond, second, etc.). The additional N3-1 PDCCH repetitions start from the end of the first PDCCH repetition for OSI. The N3-1 PDCCH occasions/subframes/slots/symbols occur one after another in time with a gap of the configured offset between each two. For the N3 PDCCH repetitions, the UE can combine one or more or all N3 repetitions (one indicated by OSI search space and N3-1 implicitly indicated) and decode PDCCH for OSI.

In some embodiments, for PDCCH repetition for paging, the NW transmits an enabling indication and/or configuration. In embodiments such as these, the enabling indication and/or configuration can be pre-defined and/or transmitted in system information (e.g., a MIB or SIB1) and/or in UE dedicated RRC signalling. The enabling indication can be explicitly indicated by a one-bit RRC parameter or implicitly indicated by the PDCCH repetition configuration. The UE receives the PDCCH repetition enabling indication and/or configuration. Accordingly, the UE monitors PDCCH repeatedly, and combines and decodes the received PDCCH repetitions.

In some embodiments, the configuration for PDCCH repetition for paging can include a repetition number R, which indicates the number of PDCCH repetitions. In embodiments such as these, the configuration can implicitly indicate the enabling of PDCCH repetition for paging. In some embodiments, the repetition number R can indicate the number of PDCCH monitoring occasions (or PDCCH subframes/slots/symbols) to be monitored, combined and decoded. For example, in some embodiments, R can be a fixed value signaled by the NW. In another example, in some embodiments, the value of R depends on the RSRP of a DL RS from the current serving cell the UE is camped on. The mapping between the value of R and the value of RSRP can be signaled. A larger value of RSRP can be mapped to a smaller value of R.

In some embodiments, for paging, the UE monitors one paging occasion (PO) per DRX cycle. A PO is a set of PDCCH monitoring occasions and can include multiple time slots (e.g., subframe or OFDM symbol) where paging DCI can be sent. One Paging Frame (PF) is one Radio Frame and may contain one or multiple PO(s) or starting point of a PO. The PF and PO for paging are determined by the following formulas: SFN for the PF is determined by (SFN+PF_offset) mod T=(T div N)*(UE_ID mod N); Index (i_s), indicating the index of the PO UE is required to monitor, is determined by i_s=floor (UE_ID/N) mod Ns.

In some embodiments, if R (e.g., indicating the number of PDCCH repetition for paging) is signaled, a UE capable of receiving PDCCH repetitions for paging monitors and/or detects (e.g., combines and decodes) R PDCCH monitoring occasions (or PDCCH subframes/slots/symbols) for the same PO as configured by the search space for paging. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the Kth transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X.

In some embodiments, in case of X equals 1, for each PDCCH monitoring occasion/subframe/slot/symbol associated to an SSB, R-1 additional PDCCH monitoring occasions (or PDCCH subframes/slots/symbols) are implicitly determined associated to the same SSB. In embodiments such as these, in a PO, the UE monitors a PDCCH occasion/subframe/slot/symbol associated to an SSB as configured by paging search space, and considers it as the first PDCCH repetition for paging. The UE then determines R-1 additional PDCCH occasions/subframes/slots/symbols as the R-1 PDCCH repetitions associated to the same SSB. For example, in some embodiments, the additional R-1 PDCCH repetitions start from the end of the first PDCCH repetition. The R-1 PDCCH occasions/subframes/slots/symbols occur one after another in time without any gap between each two. In another example, in some embodiments, a time offset can be configured, which can be in units of a symbol/slot/subframe or in time units (e.g., millisecond, second, etc.). The additional R-1 PDCCH repetitions start from the end of the first PDCCH repetition for paging. The R-1 PDCCH occasions/subframes/slots/symbols occur one after another in time with a gap of the configured offset between each two. For the R PDCCH repetitions, the UE can combine one or more or all R repetitions (one indicated by paging search space and R-1 implicitly indicated) and decode PDCCH for paging.

In some embodiments, in case of X larger than 1 (e.g., X can equal to R), the NW can configure a new paging search space with PDDCH repetition. In embodiments such as these, R can be configured in the new paging search space with PDDCH repetition. A UE supporting PDDCH repetition for paging receives PDCCH repetitions for paging according to the new paging search space. The UE monitors min (R, X) PDCCH monitoring occasions (or PDCCH subframes/slots/symbols) among all PDCCH monitoring occasions (or PDCCH subframes/slots/symbols) associated to an SSB. The first PDDCH repetition starts from the first PDCCH monitoring occasion (or PDCCH subframe/slot/symbol) in its PO, which is the (i_s+1)^{th} PO in a PF. For the R PDCCH repetitions, the UE can combine one or more or all R repetitions (one indicated by paging search space and R-1 implicitly indicated) and decode PDCCH for paging. If X>1 and if R is not configured, the UE monitors PDCCH according to the paging search space without PDDCH repetition, when the UE detects a PDCCH transmission addressed to P-RNTI within its PO, the UE is not required to monitor the subsequent PDCCH monitoring occasions for this PO.

In some embodiments, for PDCCH repetition for PEI, the NW transmits an enabling indication and/or configuration. In embodiments such as these, the enabling indication and/or configuration can be pre-defined and/or transmitted in system information (e.g., a MIB or SIB1) and/or in UE dedicated RRC signalling. In some embodiments, the enabling indication can be explicitly indicated by a one-bit RRC parameter or implicitly indicated by the PDCCH repetition configuration. The UE receives the PDCCH repetition enabling indication and/or configuration. Accordingly, the UE monitors PDCCH repeatedly, and combines and decodes the received PDCCH repetitions.

In some embodiments, the configuration for PDCCH repetition for PEI can include a repetition number Q, which indicates the number of PDCCH repetitions. In embodiments such as these, the configuration can implicitly indicate the enabling of PDCCH repetition for paging. In some embodiments, the repetition number Q can indicate the number of PDCCH monitoring occasions (or PDCCH subframes/slots/symbols) to be monitored, combined and decoded. In some embodiments, Q is a fixed value signaled by the NW. In some embodiments, the value of Q depends on the RSRP of a DL RS from the current serving cell the UE is camped on. The mapping between the value of Q and the value of RSRP can be signaled. A larger value of RSRP can be mapped to a smaller value of Q.

I some embodiments, for PEI, the UE monitors one PEI occasion per DRX cycle. A PEI occasion (PEI-O) is a set of PDCCH monitoring occasions (MOs) and can include multiple time slots (e.g., subframes or OFDM symbols) where PEI can be sent. In some embodiments, in multi-beam operations, the UE assumes that the same PEI is repeated in all transmitted beams and thus the selection of the beam(s) for the reception of the PEI is up to UE implementation. The time location of PEI-O for UE's PO is determined by a reference point and an offset. The reference point is the start of a reference frame determined by a frame-level offset from the start of the first PF of the PF(s) associated with the PEI-O, provided by pei-FrameOffset in SIB1. The offset is a symbol-level offset from the reference point to the start of the first PDCCH MO of this PEI-O, provided by firstPDCCH-MonitoringOccasionOfPEI-O in SIB1.

In some embodiments, if Q (e.g., indicating the number of PDCCH repetition for PEI) is signaled, a UE capable of receiving PDCCH repetitions for PEI monitors and/or detects (e.g., combines and decodes) Q PDCCH monitoring occasions (or PDCCH subframes/slots/symbols) for its PEI-O. In embodiments such as these, if Q is not configured, when the UE detects a PEI within its PEI-O, the UE is not required to monitor and/or detects (e.g., combine and decodes) the subsequent MO(s) associated with the same PEI-O. A PEI occasion is a set of ‘S*X’ consecutive PDCCH MOs, where ‘S’ is the number of actual transmitted SSBs determined according to ssb-PositionsInBurst in SIB1, and X is the nrofPDCCH-MonitoringOccasionPerSSB-InPO if configured or is equal to 1 otherwise. The [x*S+K]^{th} PDCCH MO for PEI in the PEI-O corresponds to the Kth transmitted SSB, where x=0, 1, . . . , X−1, K=1, 2, . . . , S. The PDCCH MOs for PEI which do not overlap with UL symbols (determined according to tdd-UL-DL-ConfigurationCommon) are sequentially numbered from zero starting from the first PDCCH MO for PEI in the PEI-O.

In some embodiments, in a case of X equals 1, for each PDCCH monitoring occasion/subframe/slot/symbol associated to an SSB, Q-1 additional PDCCH monitoring occasions (or PDCCH subframes/slots/symbols) are implicitly determined associated to the same SSB. In a PEI-O, a UE monitors a PDCCH occasion/subframe/slot/symbol associated to an SSB as configured by PEI search space, and considers it as the first PDCCH repetition for PEI. The UE then determines Q-1 additional PDCCH occasions/subframes/slots/symbols as the Q-1 PDCCH repetitions associated to the same SSB. For example, in some embodiments, the additional Q-1 PDCCH repetitions start from the end of the first PDCCH repetition. The Q-1 PDCCH occasions/subframes/slots/symbols occur one after another in time without any gap between each two. In another example, in some embodiments, a time offset can be configured, which can be in units of a symbol/slot/subframe or in a time unit (e.g., millisecond, second, etc.). The additional Q-1 PDCCH repetitions start from the end of the first PDCCH repetition. The Q-1 PDCCH occasions/subframes/slots/symbols occur one after another in time with a gap of the configured offset between each two. For the Q PDCCH repetitions, the UE can combine one or more or all Q repetitions (one indicated by PEI search space and Q-1 implicitly indicated) and decode PDCCH for PEI.

In some embodiments, in case of X larger than 1 (e.g., X can equal to Q), the NW can configure a new PEI search space with PDDCH repetition. In embodiments such as these, Q can be configured in the new PEI search space with PDDCH repetition. A UE supporting PDDCH repetition for PEI receives PDCCH repetitions for PEI according to the new paging search space. The UE monitors min (Q, X) PDCCH monitoring occasions (or PDCCH subframes/slots/symbols) among all PDCCH monitoring occasions (or PDCCH subframes/slots/symbols) associated to an SSB. The first PDDCH repetition starts from the first PDCCH monitoring occasion (or PDCCH subframe/slot/symbol) in its PEI-O. For the Q PDCCH repetitions, the UE can combine one or more or all Q repetitions (one indicated by PEI search space and Q-1 implicitly indicated) and decode PDCCH for PEI. If X>1 and if Q is not configured, the UE monitors PDCCH according to the PEI search space without PDDCH repetition, when the UE successfully received a PDCCH within its PEI-O, the UE is not required to monitor the subsequent PDCCH monitoring occasions for this PEI-O.

In some embodiments, for RRC connection reestablishment, TN to NTN reestablishment can be supported. In embodiments such as these, the NW can indicate an enabling indication for TN to NTN RRC connection re-establishment, for example, in UE dedicated signalling or in SI of current cell or in SIB1 of the selected cell for RRC reestablishment. The UE can select an NTN cell for RRC connection reestablishment, if the UE has NTN-specific assistance information acquired from current cell and/or if TN to NTN RRC connection re-establishment is enabled and/or if UE supports TN to NTN RRC connection reestablishment.

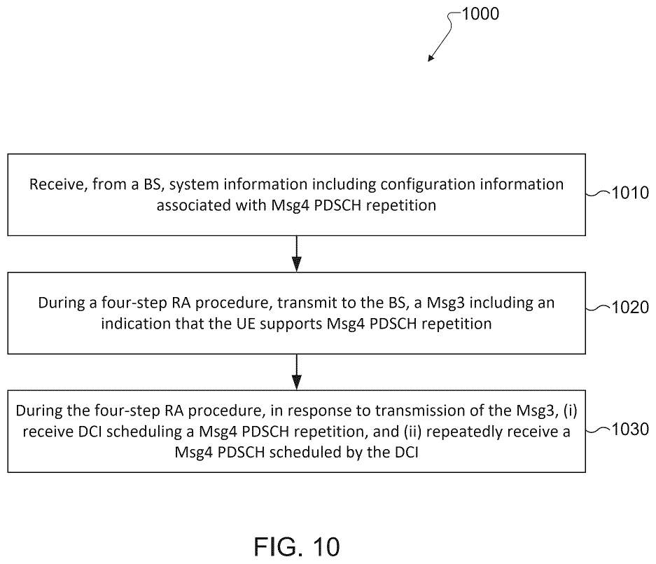

FIG. 10 illustrates an example method for repetition for downlink coverage enhancement 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for repetition for downlink coverage enhancement could be used without departing from the scope of this disclosure.

In the example of FIG. 10, the method 1000 begins at step 1010. At step 1010, a UE (such as UE 116 of FIG. 1) receives, from a BS (such as gNB 102 of FIG. 1), system information including configuration information associated with Msg4 PDSCH repetition.

At step 1020, during a four-step random access procedure, the UE transmits, to the BS, a Msg3 including an indication that the UE supports Msg4 PDSCH repetition.

At step 1030, during the four-step random access procedure, in response to transmission of the Msg3, the UE (i) receives DCI scheduling a Msg4 PDSCH repetition, and (ii) repeatedly receives a Msg4 PDSCH scheduled by the DCI.

In some embodiments, the configuration information associated with Msg4 PDSCH repetition may indicate that Msg4 PDSCH repetition is enabled, and the indication that the UE supports Msg4 PDSCH repetition may be included in the Msg3 in response to the information associated with the Msg4 PDSCH repetition indicating that Msg4 PDSCH repetition is enabled.

In some embodiments, the configuration information associated with Msg4 PDSCH repetition may be per bandwidth part (BWP).

In some embodiments, the configuration information associated with Msg4 PDSCH repetition may indicate a number of repetitions.

In some embodiments, the Msg3 may include an uplink CCCH message identified by an LCID.

In some embodiments, the LCID may indicate that the UE supports the Msg4 PDSCH repetition.

In some embodiments, the LCID may indicate at least one of: CCCH of size 48 bits for PDSCH repetition of Msg4, except for a reduced capability (RedCap) or enhanced (eRedCap) UE; CCCH of size 64 bits for PDSCH repetition of Msg4, except for a RedCap or eRedCap UE; CCCH of size 48 bits for PDSCH repetition of Msg4 of a RedCap UE; CCCH of size 64 bits for PDSCH repetition of Msg4 of a RedCap UE; CCCH of size 48 bits for PDSCH repetition of Msg4 of an eRedCap UE; CCCH of size 64 bits for PDSCH repetition of Msg4 of an eRedCap UE; CCCH of size 48 bits for PUCCH repetition of Msg4 HARQ-ACK and PDSCH repetition of Msg4, except for except for a RedCap or eRedCap UE; CCCH of size 64 bits for PUCCH repetition of Msg4 HARQ-ACK and PDSCH repetition of Msg4, except for a RedCap or eRedCap UE; CCCH of size 48 bits for PUCCH repetition of Msg4 HARQ-ACK and PDSCH repetition of Msg4 of a RedCap UE; CCCH of size 64 bits for PUCCH repetition of Msg4 HARQ-ACK and PDSCH repetition of Msg4 of a RedCap UE; CCCH of size 48 bits for PUCCH repetition of Msg4 HARQ-ACK and PDSCH repetition of Msg4 of an eRedCap UE; and CCCH of size 64 bits for PUCCH repetition of Msg4 HARQ-ACK and PDSCH repetition of Msg4 of an eRedCap UE.

Although FIG. 10 illustrates one example method for repetition for downlink coverage enhancement 1000, various changes may be made to FIG. 10. For example, while shown as a series of steps, various steps in FIG. 10 could overlap, occur in parallel, occur in a different order, occur any number of times, be omitted, or replaced by other steps.

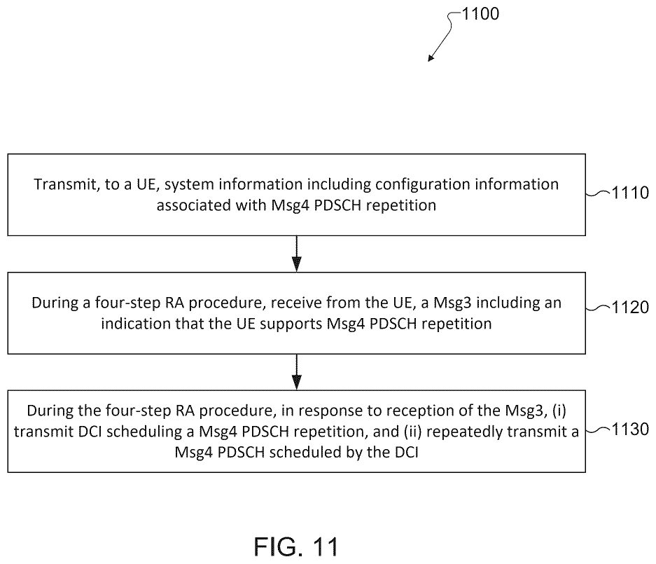

FIG. 11 illustrates another example method for repetition for downlink coverage enhancement 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for repetition for downlink coverage enhancement could be used without departing from the scope of this disclosure.

In the example of FIG. 11, the method 1100 begins at step 1110. At step 1110, a BS (such as gNB 102 of FIG. 1) transmits, to a UE (such as UE 116 of FIG. 1), system information including configuration information associated with Msg4 PDSCH repetition.

At step 1120, during a four-step random access procedure, the BS receives, from the UE, a Msg3 including an indication that the UE supports Msg4 PDSCH repetition.

At step 1130, during the four-step random access procedure, in response to reception of the Msg3, the BS (i) transmits DCI scheduling a Msg4 PDSCH repetition, and (ii) repeatedly transmits a Msg4 PDSCH scheduled by the DCI.

In some embodiments, the configuration information associated with Msg4 PDSCH repetition may indicate that Msg4 PDSCH repetition is enabled, and the indication that the UE supports Msg4 PDSCH repetition may be included in the Msg3 in response to the information associated with the Msg4 PDSCH repetition indicating that Msg4 PDSCH repetition is enabled.

In some embodiments, the configuration information associated with Msg4 PDSCH repetition may be per bandwidth part (BWP).

In some embodiments, the configuration information associated with Msg4 PDSCH repetition may indicate a number of repetitions.

In some embodiments, the Msg3 may include an uplink CCCH message identified by an LCID.

In some embodiments, the LCID may indicate that the UE supports the Msg4 PDSCH repetition, by indicating at least one of: CCCH of size 48 bits for PDSCH repetition of Msg4, except for a reduced capability (RedCap) or enhanced (eRedCap) UE; CCCH of size 64 bits for PDSCH repetition of Msg4, except for a RedCap or eRedCap UE; CCCH of size 48 bits for PDSCH repetition of Msg4 of a RedCap UE; CCCH of size 64 bits for PDSCH repetition of Msg4 of a RedCap UE; CCCH of size 48 bits for PDSCH repetition of Msg4 of an eRedCap UE; CCCH of size 64 bits for PDSCH repetition of Msg4 of an eRedCap UE; CCCH of size 48 bits for PUCCH repetition of Msg4 HARQ-ACK and PDSCH repetition of Msg4, except for except for a RedCap or eRedCap UE; CCCH of size 64 bits for PUCCH repetition of Msg4 HARQ-ACK and PDSCH repetition of Msg4, except for a RedCap or eRedCap UE; CCCH of size 48 bits for PUCCH repetition of Msg4 HARQ-ACK and PDSCH repetition of Msg4 of a RedCap UE; CCCH of size 64 bits for PUCCH repetition of Msg4 HARQ-ACK and PDSCH repetition of Msg4 of a RedCap UE; CCCH of size 48 bits for PUCCH repetition of Msg4 HARQ-ACK and PDSCH repetition of Msg4 of an eRedCap UE; and CCCH of size 64 bits for PUCCH repetition of Msg4 HARQ-ACK and PDSCH repetition of Msg4 of an eRedCap UE.

Although FIG. 11 illustrates one example method for repetition for downlink coverage enhancement 1100, various changes may be made to FIG. 11. For example, while shown as a series of steps, various steps in FIG. 11 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving, from a base station (BS), system information including configuration information associated with Message 4 (Msg4) physical downlink shared channel (PDSCH) repetition; and
during a four-step random access procedure:
transmitting, to the BS, a Message 3 (Msg3) including an indication that the UE supports Msg4 PDSCH repetition; and
in response to transmission of the Msg3, (i) receiving downlink control information (DCI) scheduling a Msg4 PDSCH repetition, and (ii) repeatedly receiving a Msg4 PDSCH scheduled by the DCI.

2. The method of claim 1, wherein:
the configuration information associated with Msg4 PDSCH repetition indicates that Msg4 PDSCH repetition is enabled; and
the indication that the UE supports Msg4 PDSCH repetition is included in the Msg3 in response to the information associated with the Msg4 PDSCH repetition indicating that Msg4 PDSCH repetition is enabled.

3. The method of claim 1, wherein the configuration information associated with Msg4 PDSCH repetition is per bandwidth part (BWP).

4. The method of claim 1, wherein the configuration information associated with Msg4 PDSCH repetition indicates a number of repetitions.

5. The method of claim 1, wherein the Msg3 includes an uplink common control channel (CCCH) message identified by a logical channel identification (LCID).

6. The method of claim 5, wherein the LCID indicates that the UE supports the Msg4 PDSCH repetition.

7. The method of claim 5, wherein the LCID indicates at least one of:
CCCH of size 48 bits for PDSCH repetition of Msg4, except for a reduced capability (RedCap) or enhanced (eRedCap) UE;
CCCH of size 64 bits for PDSCH repetition of Msg4, except for a RedCap or eRedCap UE;
CCCH of size 48 bits for PDSCH repetition of Msg4 of a RedCap UE;
CCCH of size 64 bits for PDSCH repetition of Msg4 of a RedCap UE;
CCCH of size 48 bits for PDSCH repetition of Msg4 of an eRedCap UE;
CCCH of size 64 bits for PDSCH repetition of Msg4 of an eRedCap UE;
CCCH of size 48 bits for PUCCH repetition of Msg4 HARQ-ACK and PDSCH repetition of Msg4, except for except for a RedCap or eRedCap UE;
CCCH of size 64 bits for PUCCH repetition of Msg4 HARQ-ACK and PDSCH repetition of Msg4, except for a RedCap or eRedCap UE;
CCCH of size 48 bits for PUCCH repetition of Msg4 HARQ-ACK and PDSCH repetition of Msg4 of a RedCap UE;
CCCH of size 64 bits for PUCCH repetition of Msg4 HARQ-ACK and PDSCH repetition of Msg4 of a RedCap UE;
CCCH of size 48 bits for PUCCH repetition of Msg4 HARQ-ACK and PDSCH repetition of Msg4 of an eRedCap UE; and
CCCH of size 64 bits for PUCCH repetition of Msg4 HARQ-ACK and PDSCH repetition of Msg4 of an eRedCap UE.

8. A method of operating a base station (BS), the method comprising:
transmitting, to a user equipment (UE), system information including configuration information associated with Message 4 (Msg4) physical downlink shared channel (PDSCH) repetition; and
during a four-step random access procedure:
receiving, from the UE, a Message 3 (Msg3) including an indication that the UE supports Msg4 PDSCH repetition; and
in response to receiving the Msg3, (i) transmitting downlink control information (DCI) scheduling a Msg4 PDSCH repetition, and (ii) repeatedly transmitting a Msg4 PDSCH scheduled by the DCI.

9. The method of claim 8, wherein:
the configuration information associated with Msg4 PDSCH repetition indicates that Msg4 PDSCH repetition is enabled; and
the indication that the UE supports Msg4 PDSCH repetition is included in the Msg3 in response to the information associated with the Msg4 PDSCH repetition indicating that Msg4 PDSCH repetition is enabled.

10. The method of claim 8, wherein the configuration information associated with Msg4 PDSCH repetition is per bandwidth part (BWP).

11. The method of claim 8, wherein the configuration information associated with Msg4 PDSCH repetition indicates a number of repetitions.

12. The method of claim 8, wherein the Msg3 includes an uplink common control channel (CCCH) message identified by a logical channel identification (LCID).

13. The method of claim 12, wherein the LCID indicates that the UE supports the Msg4 PDSCH repetition by indicating at least one of:
CCCH of size 48 bits for PDSCH repetition of Msg4, except for a reduced capability (RedCap) or enhanced (eRedCap) UE;
CCCH of size 64 bits for PDSCH repetition of Msg4, except for a RedCap or eRedCap UE;
CCCH of size 48 bits for PDSCH repetition of Msg4 of a RedCap UE;
CCCH of size 64 bits for PDSCH repetition of Msg4 of a RedCap UE;
CCCH of size 48 bits for PDSCH repetition of Msg4 of an eRedCap UE;
CCCH of size 64 bits for PDSCH repetition of Msg4 of an eRedCap UE;
CCCH of size 48 bits for PUCCH repetition of Msg4 HARQ-ACK and PDSCH repetition of Msg4, except for except for a RedCap or eRedCap UE;
CCCH of size 64 bits for PUCCH repetition of Msg4 HARQ-ACK and PDSCH repetition of Msg4, except for a RedCap or eRedCap UE;
CCCH of size 48 bits for PUCCH repetition of Msg4 HARQ-ACK and PDSCH repetition of Msg4 of a RedCap UE;
CCCH of size 64 bits for PUCCH repetition of Msg4 HARQ-ACK and PDSCH repetition of Msg4 of a RedCap UE;
CCCH of size 48 bits for PUCCH repetition of Msg4 HARQ-ACK and PDSCH repetition of Msg4 of an eRedCap UE; and
CCCH of size 64 bits for PUCCH repetition of Msg4 HARQ-ACK and PDSCH repetition of Msg4 of an eRedCap UE.

14. An electronic device comprising:
at least one processor including processing circuitry; and
memory storing instructions, wherein the instructions, when executed by the at least one processor individually or collectively, cause the electronic device to:
receive, from a base station (BS), system information including configuration information associated with Message 4 (Msg4) physical downlink shared channel (PDSCH) repetition; and
during a four-step random access procedure:
transmit, to the BS, a Message 3 (Msg3) including an indication that the electronic device supports Msg4 PDSCH repetition; and
in response to transmission of the Msg3, (i) receive downlink control information (DCI) scheduling a Msg4 PDSCH repetition, and (ii) repeatedly receive a Msg4 PDSCH scheduled by the DCI.

15. The electronic device of claim 14, wherein:
the configuration information associated with Msg4 PDSCH repetition indicates that Msg4 PDSCH repetition is enabled; and
the indication that the electronic device supports Msg4 PDSCH repetition is included in the Msg3 in response to the information associated with the Msg4 PDSCH repetition indicating that Msg4 PDSCH repetition is enabled.

16. The electronic device of claim 14, wherein the configuration information associated with Msg4 PDSCH repetition is per bandwidth part (BWP).

17. The electronic device of claim 14, wherein the configuration information associated with Msg4 PDSCH repetition indicates a number of repetitions.

18. The electronic device of claim 14, wherein the Msg3 includes an uplink common control channel (CCCH) message identified by a logical channel identification (LCID).

19. The electronic device of claim 18, wherein the LCID indicates that the electronic device supports the Msg4 PDSCH repetition.

20. The electronic device of claim 18, wherein the LCID indicates at least one of:
CCCH of size 48 bits for PDSCH repetition of Msg4, except for a reduced capability (RedCap) or enhanced (eRedCap) UE;
CCCH of size 64 bits for PDSCH repetition of Msg4, except for a RedCap or eRedCap UE;
CCCH of size 48 bits for PDSCH repetition of Msg4 of a RedCap UE;
CCCH of size 64 bits for PDSCH repetition of Msg4 of a RedCap UE;
CCCH of size 48 bits for PDSCH repetition of Msg4 of an eRedCap UE;
CCCH of size 64 bits for PDSCH repetition of Msg4 of an eRedCap UE;
CCCH of size 48 bits for PUCCH repetition of Msg4 HARQ-ACK and PDSCH repetition of Msg4, except for except for a RedCap or eRedCap UE;
CCCH of size 64 bits for PUCCH repetition of Msg4 HARQ-ACK and PDSCH repetition of Msg4, except for a RedCap or eRedCap UE;
CCCH of size 48 bits for PUCCH repetition of Msg4 HARQ-ACK and PDSCH repetition of Msg4 of a RedCap UE;
CCCH of size 64 bits for PUCCH repetition of Msg4 HARQ-ACK and PDSCH repetition of Msg4 of a RedCap UE;
CCCH of size 48 bits for PUCCH repetition of Msg4 HARQ-ACK and PDSCH repetition of Msg4 of an eRedCap UE; and
CCCH of size 64 bits for PUCCH repetition of Msg4 HARQ-ACK and PDSCH repetition of Msg4 of an eRedCap UE.
